(19) United States
(12) Patent Application Publication
(10) Pub. No.: US 2015/0241681 A1
(43) Pub. Date: Aug. 27, 2015

(54) LASER SCANNING MICROSCOPE SYSTEM AND SAMPLING DEVICE

(71) Applicant: Sony Corporation, Tokyo (JP)

(72) Inventors: Masaaki Hara, Tokyo (JP); Goro Fujita, Kanagawa (JP); Tsutomu Maruyama, Kanagawa (JP)

(73) Assignee: Sony Corporation, Tokyo (JP)

(21) Appl. No.: 14/626,120

(22) Filed: Feb. 19, 2015

(30) Foreign Application Priority Data
Feb. 26, 2014 (JP) 2014-035323

(51) Int. Cl. G02B 21/00; G02B 26/10

(52) U.S. Cl. CPC G02B 21/0084; G02B 21/0032; G02B 21/0076; G02B 21/0048; G02B 26/101

(57) ABSTRACT

There is provided a laser scanning microscope system including a laser output unit configured to output a laser beam in a pulse light emission manner at a predetermined oscillation frequency, an intermittent light-emission unit configured to intermittently emit the laser beam output from the laser output unit at a predetermined intermittent light-emission period, a detector configured to convert fluorescence emitted from a fluorescent substance excited at a time of reception of the intermittently emitted laser beam into an electric signal, and a sampling unit configured to sample the electric signal at a period corresponding to the intermittent light-emission period.

### CROSS REFERENCE TO RELATED APPLICATIONS

This application claims the benefit of Japanese Priority Patent Application JP 2014-035323 filed Feb. 26, 2014, the entire contents of which are incorporated herein by reference.

### BACKGROUND

The present disclosure relates to a laser scanning microscope system and a sampling device.

In the related art, for example, Japanese Patent No. 5007092 discloses a scanning microscope that includes a scanning device scanning an object and performs synchronization between an oscillation pulse frequency and a sampling frequency.

### SUMMARY

In recent years, microscopes having a high output equal to or greater than 100 W due to an MOPA type light source using a semiconductor laser have been developed. However, in a case in which a biological object is a measurement target, a powerful laser beam unfortunately damages the biological object.

In recent years, microscopes having a high output equal to or greater than 100 W due to an MOPA type light source using a semiconductor laser have been developed. However, in a case in which a biological object is a measurement target, a powerful laser beam unfortunately damages the biological object.

In laser scanning microscopes, however, fluorescence obtained from fluorescent substances is converted into electric signals by detectors such as PMTs. However, when a laser beam is emitted intermittently, an acquired image may unfortunately deteriorate depending on sampling of A/D conversion after conversion.

In Japanese Patent No. 5007092, it is described that the synchronization between the oscillation pulse frequency and the sampling frequency is performed. However, an intermittent light-emission period when intermittent light emission is performed is not mentioned. Further, in the technology disclosed in Japanese Patent No. 5007092, even when high-speed sampling is performed in synchronization with pulse light emission, an improvement in resolution is not realized and it is also difficult to increase a signal amount.

Accordingly, it is desirable to suppress deterioration in an image by optimally sampling an electric signal by the fluorescence obtained from the fluorescent substances when a laser beam is emitted intermittently.

According to an embodiment of the present disclosure, there is provided a laser scanning microscope system including a laser output unit configured to output a laser beam in a pulse light emission manner at a predetermined oscillation frequency, an intermittent light-emission unit configured to intermittently emit the laser beam output from the laser output unit at a predetermined intermittent light-emission period, a detector configured to convert fluorescence acquired from a fluorescent substance excited at a time of reception of the intermittently emitted laser beam into an electric signal, and a sampling unit configured to sample the electric signal at a period corresponding to the intermittent light-emission period.

The sampling unit may include an A/D conversion unit configured to sample the electric signal at a sampling period higher than the intermittent light-emission period, and a first interpolation unit configured to extract only data synchronized with the intermittent light-emission period from an output of the A/D conversion unit.

The sampling unit further may include a lowpass filter configured to perform band limitation on an output of the first interpolation unit so that a frequency band is equal to or less than ½ of a pixel frequency, and a second interpolation unit configured to re-sample an output of the lowpass filter at a clock of the pixel frequency.

An optical frequency band of the laser output unit may be equal to or less than ½ of the intermittent light-emission frequency.

Frequencies and phases related to sampling and intermittent light emission may be the same.

The laser output unit may be a mode-locked laser that outputs the laser beam for two-photon excitation.

The laser output unit may be a pulse laser configured by a mode-locked laser including an external resonator and a light source of a semiconductor optical amplifier and performs intermittent light emission by the intermittent light-emission unit while synchronizing the semiconductor optical amplifier with oscillation of the mode-locked laser.

A sampling signal providing a period of sampling to the sampling unit and an intermittent light-emission signal providing the intermittent light-emission period to the intermittent light-emission unit may be the same signals.

The laser output unit or the intermittent light-emission unit may cause the laser beam to be incident on an object during only a predetermined effective light-emission period.

The laser scanning microscope system may include a first galvanomirror configured to perform scanning with the laser beam in a first direction of a surface of the object, a second galvanomirror configured to perform scanning with the laser beam in a second direction perpendicular to the first direction of the surface of the object, and a galvanomirror control unit configured to control the first and second galvanomirrors. When the scanning in the first direction is completed, the galvanomirror control unit may return the laser beam to a start position of the first direction, and performs the scanning in the second direction by one line of the laser beam and subsequently performs the scanning in the first direction again. The effective light-emission period may be at least a part of a period in which the scanning in the first direction is performed.

The laser scanning microscope system may include a lowpass filter configured to perform band limitation on the electric signal output from the detector and input the electric signal to the sampling unit. The lowpass filter may perform the band limitation so that a Nyquist sampling theorem is established for a frequency of sampling.

The lowpass filter may perform the band limitation so that ½ or less of the frequency of the sampling is satisfied.

A clock of the intermittent light-emission period may be input to the first interpolation unit and the first interpolation unit may extract only data synchronized with the intermittent light-emission period based on the clock.

The laser scanning microscope system may further include a clock generation unit configured to generate a clock corresponding to the intermittent light-emission period. The first interpolation unit may extract only data synchronized with the intermittent light-emission period based on the clock.

According to another embodiment of the present disclosure, there is provided a sampling device including an A/D conversion unit configured to sample an electric signal at a sampling period higher than a predetermined intermittent light-emission period when the electric signal is input from a detector of a laser scanning microscope system including a laser output unit that outputs a laser beam in a pulse light emission manner at a predetermined oscillation frequency, an intermittent light-emission unit that intermittently emits the laser beam output from the laser output unit at the intermittent light-emission period, and the detector that converts fluorescence emitted from a fluorescent substance excited at a time of reception of the intermittently emitted laser beam into the electric signal, a first interpolation unit configured to extract only data synchronized with the intermittent light-emission period from an output of the A/D conversion unit, a lowpass filter configured to perform band limitation on an output of the first interpolation unit so that a frequency band is equal to or less than ½ of a pixel frequency, and a D/A conversion unit configured to perform D/A conversion on an output of the lowpass filter to return to an input terminal to which the electric signal of the detector of the laser scanning microscope system is input.

According to still another embodiment of the present disclosure, there is provided a sampling device including an A/D conversion unit configured to sample an electric signal at a sampling period higher than a predetermined intermittent light-emission period when the electric signal is input from a detector of a laser scanning microscope system including a laser output unit that outputs a laser beam in a pulse light emission manner at a predetermined oscillation frequency, an intermittent light-emission unit that intermittently emits the laser beam output from the laser output unit at the intermittent light-emission period, and the detector that converts fluorescence emitted from a fluorescent substance excited at a time of reception of the intermittently emitted laser beam into the electric signal, a first interpolation unit configured to extract only data synchronized with the intermittent light-emission period from an output of the A/D conversion unit, and a lowpass filter configured to perform band limitation on an output of the first interpolation unit so that a frequency band is equal to or less than ½ of a pixel frequency and to return as an A/D conversion output of the electric signal of the detector to the laser scanning microscope system.

According to yet another embodiment of the present disclosure, there is provided a sampling device including a first interpolation unit configured to extract only data synchronized with a predetermined intermittent light-emission period from an output of an A/D conversion unit when the output of the A/D conversion unit of a laser scanning microscope system is input, the laser scanning microscope system including a laser output unit that outputs a laser beam in a pulse light emission manner at a predetermined oscillation frequency, an intermittent light-emission unit that intermittently emits the laser beam output from the laser output unit at the intermittent light-emission period, a detector that converts fluorescence emitted from a fluorescent substance excited at a time of reception of the intermittently emitted laser beam into an electric signal, and an A/D conversion unit that samples the electric signal at a sampling period higher than the intermittent light-emission period, and a lowpass filter configured to perform band limitation on an output of the first interpolation unit so that a frequency band is equal to or less than ½ of a pixel frequency and return as an A/D conversion output of the electric signal of the detector to the laser scanning microscope system.

The laser output unit may be a pulse laser configured by a mode-locked laser including an external resonator and a light source of a semiconductor optical amplifier and may perform intermittent light emission by the intermittent light-emission unit while synchronizing the semiconductor optical amplifier with oscillation of the mode-locked laser.

The laser output unit may be not able to be intermittently driven and the intermittent light-emission unit may perform the intermittent light emission using a light modulation element that blocks a laser output from the laser output unit.

According to an embodiment of the present disclosure, when a laser beam is emitted intermittently, it is possible to optimally sample electric signals by fluorescence emitted from the excited fluorescent substances and suppress deterioration in an image.

### BRIEF DESCRIPTION OF THE DRAWINGS

FIG. 1 is a schematic diagram illustrating an example of a microscope system according to an embodiment of the present disclosure;

FIG. 2 is a schematic diagram illustrating the configuration of a light source in detail;

FIG. 3 is a diagram illustrating characteristics when peak power of a laser is increased by intermittent light emission;

FIG. 4 is a schematic diagram illustrating the configuration of a microscope body;

FIG. 5 is a schematic diagram illustrating a method of generating a 2-dimensional image using a raster scanning scheme;

FIG. 6 is a schematic diagram illustrating a case in which a sampling period is shorter than an intermittent light-emission period T;

FIG. 7 is a schematic diagram illustrating a case in which a sampling period is longer than an intermittent light-emission period T;

FIG. 8 is a schematic diagram illustrating a case in which a sampling period is caused to be identical to an intermittent light-emission period T;

FIG. 9 is a schematic diagram illustrating an example of a configuration in which a host PC and a monitor are added to the system illustrated in FIG. 1;

FIG. 10 is a schematic diagram illustrating a system performing high-speed sampling in FIG. 9;

FIG. 11 is a schematic diagram illustrating a configuration in which intermittent light emission by a light source control unit is performed asynchronously with a sampling clock in FIG. 10;

FIG. 12 is a schematic diagram illustrating an interpolation process in a re-sampling unit;

FIG. 13 is a schematic diagram illustrating a process in the re-sampling unit;

FIG. 14 is a schematic diagram illustrating the configuration of the re-sampling unit;

FIG. 15 is a schematic diagram illustrating waveforms processed by the re-sampling unit in the system illustrated in FIG. 14;

FIG. 16 is a schematic diagram illustrating the configuration of a synchronous re-sampling circuit;

FIG. 17 is a schematic diagram illustrating waveforms processed by the re-sampling unit in the configuration illustrated in FIG. 16;

FIG. 18 is a schematic diagram illustrating the configuration of an interpolation circuit illustrated in FIG. 16;

FIG. 19 is a schematic diagram illustrating signals input to the interpolation circuit;

FIG. 20 is a schematic diagram illustrating an example of a configuration in which an output of a DEF 644 is fed back to an SEL 646 in the configuration of FIG. 18;

FIG. 21 is a schematic diagram illustrating data subjected to (f) interpolation in the configuration of FIG. 20;

FIG. 22 is a schematic diagram illustrating the configuration of a system according to a third embodiment;

FIG. 23 is a schematic diagram illustrating a basic configuration of a synchronous sampling adapter;

FIG. 24 is a schematic diagram illustrating waveforms processed by the synchronous sampling adapter with the configuration illustrated in FIG. 23;

FIG. 25 is a schematic diagram illustrating an example of a configuration in which a digital PLL and a delay circuit are added to the synchronous sampling adapter in FIG. 23;

FIG. 26 is a schematic diagram illustrating the configuration of the synchronous sampling adapter in which a D/A conversion unit and an analog LPF are omitted in the configuration of FIG. 25;

FIG. 27 is a schematic diagram illustrating connection of the synchronous sampling adapter illustrated in FIG. 26 with a microscope body and dedicated hardware;

FIG. 28 is a schematic diagram illustrating the configuration of the synchronous sampling adapter in which an A/D conversion unit, the D/A conversion unit, and the analog LPF are omitted in the configuration of FIG. 25; and

FIG. 29 is a schematic diagram illustrating connection of the synchronous sampling adapter illustrated in FIG. 28 with a microscope body and dedicated hardware.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be made in the following order.

1. First Embodiment

1.1. Microscope system

1.2. Example of configuration of light source

1.3. Example of the configuration of microscope system

1.4. Relation between sampling period and intermittent light-emission period

1.5. Example of configuration in which sampling period is caused to be identical to intermittent driving period

1.6. Configuration of lowpass filter

1.7. Synchronization between optical pulse of laser beam and modulation of laser beam

1.8. Relation between optical resolution and sampling frequency

2. Second embodiment (example of high-speed sampling)

3. Third embodiment (example of synchronization sampling adapter)

### 1. First Embodiment

### [1.1. Microscope System]

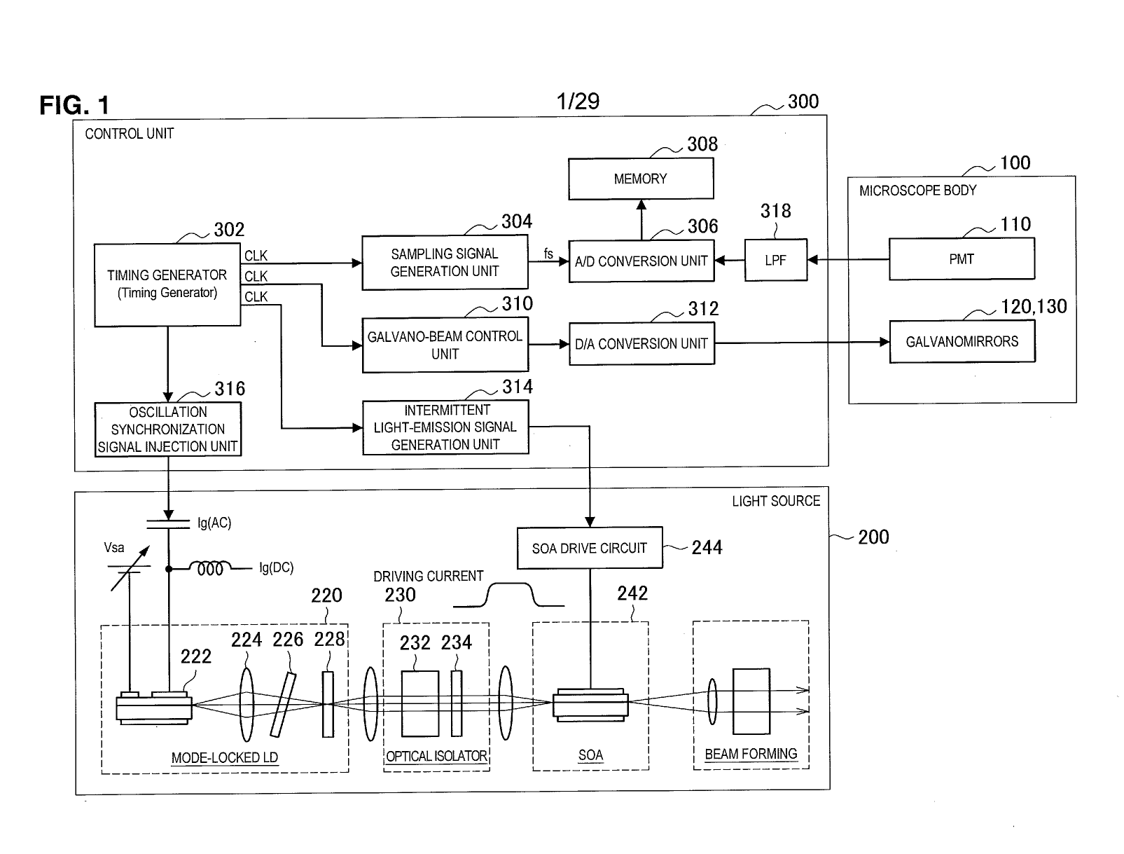

First, a microscope system according to an embodiment of the present disclosure will be described with reference to FIG. 1. FIG. 1 is a schematic diagram illustrating an example of the microscope system according to the embodiment. The microscope system is a laser scanning microscope for biological analysis and is particularly a microscope system including a two-photon excitation light source. As illustrated in FIG. 1, a microscope system 1000 is configured to include a microscope body 100, a light source 200, and a control unit 300.

The microscope body 100 is configured as a laser scanning microscope and scans a measurement sample S 3-dimensionally in the vertical direction, the horizontal direction, and the depth direction of the measurement sample to generate an image data group corresponding to an expanded image group of the measurement sample S. Therefore, the microscope body 100 is configured to include a photomultiplier tube (PMT) and galvanomirrors. The configuration of the microscope body 100 will be described in detail below.

The light source 200 uses a pulse laser and is a master oscillator power amplifier (MOPA) type light source configured to include a laser (mode-locked laser diode (hereinafter referred to as an MLLD)) including an external resonator and a semiconductor optical amplifier (SOA). In recent years, microscopes having a high output equal to or greater than 100 W due to an MOPA type light source using a semiconductor laser have been developed. The light source has characteristics including a low price and a small size. Therefore, when the light source can be mounted on a multi-photon microscope of a middle range, its applicability in a wide variety of research organizations is increased, and thus considerable contribution can be expected in medical and pharmaceutical fields. In the embodiment, a microscope system using such an MOPA type light source, in particular, a microscope system using a two-photon excitation light source, will be described.

The control unit 300 has a function of controlling the microscope body 100 and the light source 200. The configuration of the control unit 300 will be described in detail below.

### [1.2. Example of Configuration of Light Source]

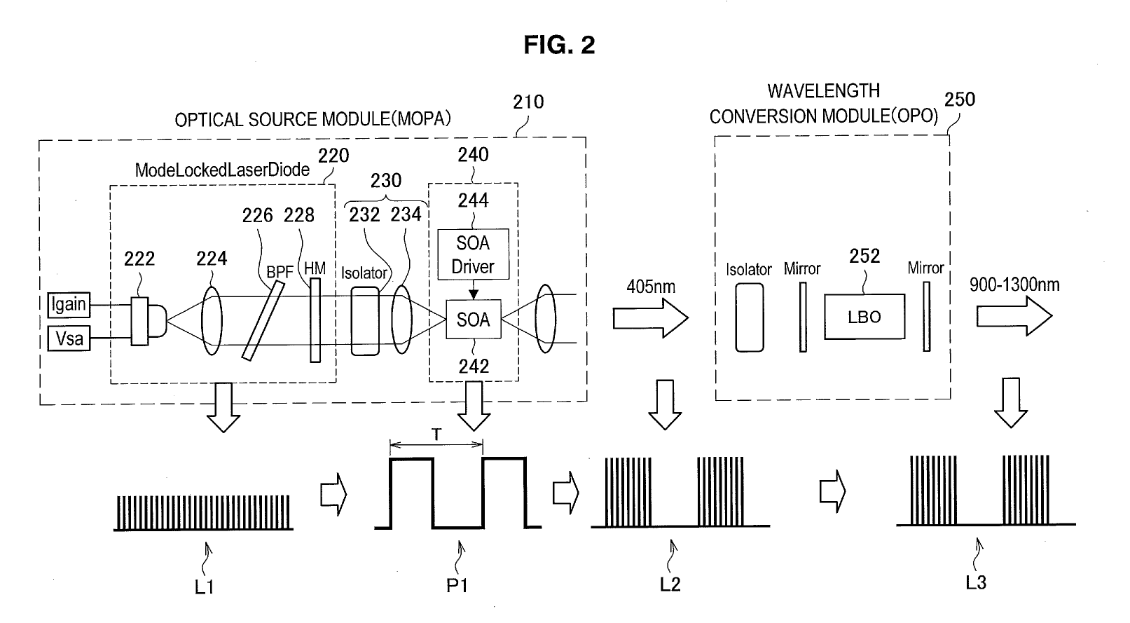

FIG. 2 is a schematic diagram illustrating the configuration of the light source 200 in detail. The light source 200 is configured to include an MOPA 210 in which a mode-locked oscillation type laser and an optical amplifier are combined and a wavelength conversion module (OPO) 250. The MOPA 210 includes a mode-locked laser unit (mode-locked laser diode) 220, an optical isolator unit 230, and an optical amplifier unit (SOA unit) 240.

The lower portion of FIG. 2 illustrates pulse waveforms L1, L2, and L3 of laser beams output from the mode-locked laser unit 220, the optical amplifier unit 240, and the wavelength conversion module 250 and a pulse waveform P1 for intermittent driving to be described below.

The mode-locked laser unit 220 is configured to include a semiconductor laser 222 and elements, i.e., a lens 224, a bandpass filter 226, and a mirror 228 that pass the laser beam radiated from the semiconductor laser 222. The bandpass filter 226 has a function of transmitting light within a given wavelength range and not transmitting light out of the range. An external resonator (space resonator) is configured between a rear-side minor of the semiconductor laser 222 and the mirror 228, and the frequency of the laser beam radiated from the mode-locked laser unit 220 is decided by a path length of the external resonator. Thus, since the frequency of the laser beam can be forcibly locked to a specific frequency, a mode of the laser beam can be locked.

The mode-locked laser unit 220 can synchronize a short pulse with a period (for example, about 1 GHz) longer than a normal semiconductor laser by configuring the external resonator. Therefore, a laser beam L1 output from the mode-locked laser unit 220 has low average power and a high peak, and thus damage to a biological object becomes small and photon efficiency becomes high.

The optical isolator unit 230 is disposed on the rear stage of the mode-locked laser unit 220. The optical isolator unit 230 is configured to include an optical isolator 232 and a mirror 234. The optical isolator unit 230 has a function of preventing light reflected from an optical component or the like on the rear stage from being incident on the semiconductor laser 222.

The optical amplifier unit (SOA unit) 240 functions as an optical modulation unit that amplifies and modulates the laser beam radiated from the semiconductor laser 222 and is disposed on the rear stage of the optical isolator unit 230. Since the laser beam output from the mode-locked laser unit 220 has relatively small power, the laser beam is amplified by the optical amplifier unit 240. The optical amplifier unit 240 is configured to include a semiconductor optical amplifier (SOA), i.e., a semiconductor optical amplifier 242 and an SOA driver 244 controlling the semiconductor optical amplifier 242. The semiconductor optical amplifier 242 is an optical amplifier with a small size and a low cost and can be used as an optical gate and a light switch turning light on and off. In the embodiment, the laser beam radiated from the semiconductor laser 222 is modulated by ON and OFF of the semiconductor optical amplifier 242.

In the optical amplifier unit (SOA unit) 240, the laser beam is amplified according to the magnitude of a control current (direct current). Further, the optical amplifier unit 240 turns the laser beam on and off with the pulse waveform L1 in a predetermined period T by performing intermittent driving by the control current with the pulse waveform P1 illustrated in FIG. 2 at the time of the amplification and outputs an intermittent laser beam (the pulse waveform L2). By generating the pulse waveform with a desired timing and period in this way, it is possible to realize synchronization with a control signal which the system has. Thus, for example, in the case of the MOPA type light source, intermittent driving can be realized by performing intermittent driving in the semiconductor optical amplifier 242 (in which a semiconductor optical amplifier is abbreviated to an SOA) on the rear stage that amplifies the pulse of an oscillation unit on the front stage. In the case of the MOPA type light source, the optical amplifier unit 240 (the semiconductor optical amplifier 242) functions as an intermittent light-emitting unit.

In the embodiment, since the MLLD is used, the frequency of the laser beam output from the semiconductor laser 222 is, for example, in the range of about 500 MHz to about 1 GHz and the pulse width thereof is in the range of about 0.5 [ps] to about 1.0 [ps]. As will be described below, by injecting a transmission synchronization signal from an oscillation synchronization signal injection unit 316, an oscillation pulse output from the semiconductor laser 222 can also be synchronized with the control signal which the system has in addition to the synchronization of the intermittent driving by the SOA unit. Also, when TiSa is used, the oscillation frequency of the laser beam is in the range of about 40 MHz to about 80 MHz and the pulse width thereof is in the range of about 0.1 [ps] to about 0.2 [ps]. On the other hand, by using the MLLD, it is possible to output the laser beam with a higher oscillation frequency.

In the embodiment, the wavelength of the laser beam output from the optical amplifier unit 240 is, for example, 405 nm. Since the wavelength of 405 nm is a wavelength in which optical absorption is large, the wavelength is converted into a wavelength (about 900 nm to about 1300 nm) reaching the inside of a biological object and producing a two-photon effect at a high density. For this reason, the laser beam output from the optical amplifier unit 240 is input to the wavelength conversion module 250 on the rear stage, so that the wavelength thereof is converted by an LBO 252 of the wavelength conversion module 250.

For example, the LBO 252 of the wavelength conversion module 250 converts the input laser beam (the pulse waveform L2) into two wavelengths. Then, of the two converted wavelengths, the laser beam (the pulse waveform L3) with the longer wavelength is output from the wavelength conversion module 250. In the embodiment, the wavelength conversion module 250 is not an indispensable constituent element and an object (the measurement sample S) can also be irradiated using the laser beam output from the optical amplifier unit 240 as final light.

Incidentally, in observation of a biological object with a laser microscope, in order to reduce damage to the object, it is effective to lower average power of a laser and increase peak power of the laser. Also, a laser chip included in the MOPA type light source using a semiconductor laser is small in size, and therefore an operational limitation is considered to be imposed due to heat generation caused by a load of high power.

Since the light source 200 according to the embodiment outputs an intermittent laser beam (the pulse wavelength L2) and performs an intermittent operation, a peak at the time of the light emission can be increased despite the fact that the average power is the same, compared to a case in which the intermittent operation is not performed. Also, by performing the intermittent operation, it is possible to suppress heat generation caused by a load of high power.

In the embodiment, the light source 200 used as the two-photon excitation light source 200 excites a fluorescent substance with two photons. In particular, in a microscope using a two-photon excitation light source, a figure of merit FOM (=(Peak Power)²×Pulse Width×Frequency=Peak Power×Average Power) is known. According to the figure of merit, an output can be increased in proportion to a product of peak power and average power. Accordingly, in observation of a biological object with a laser microscope, in order to suppress damage to an object to be as small as possible and increase an output, it is effective to lower the average power and to increase the peak power. Therefore, in the embodiment, a duty (DUTY=Pulse WidthxFrequency) ratio is lowered and the peak power is increased by performing the intermittent operation.

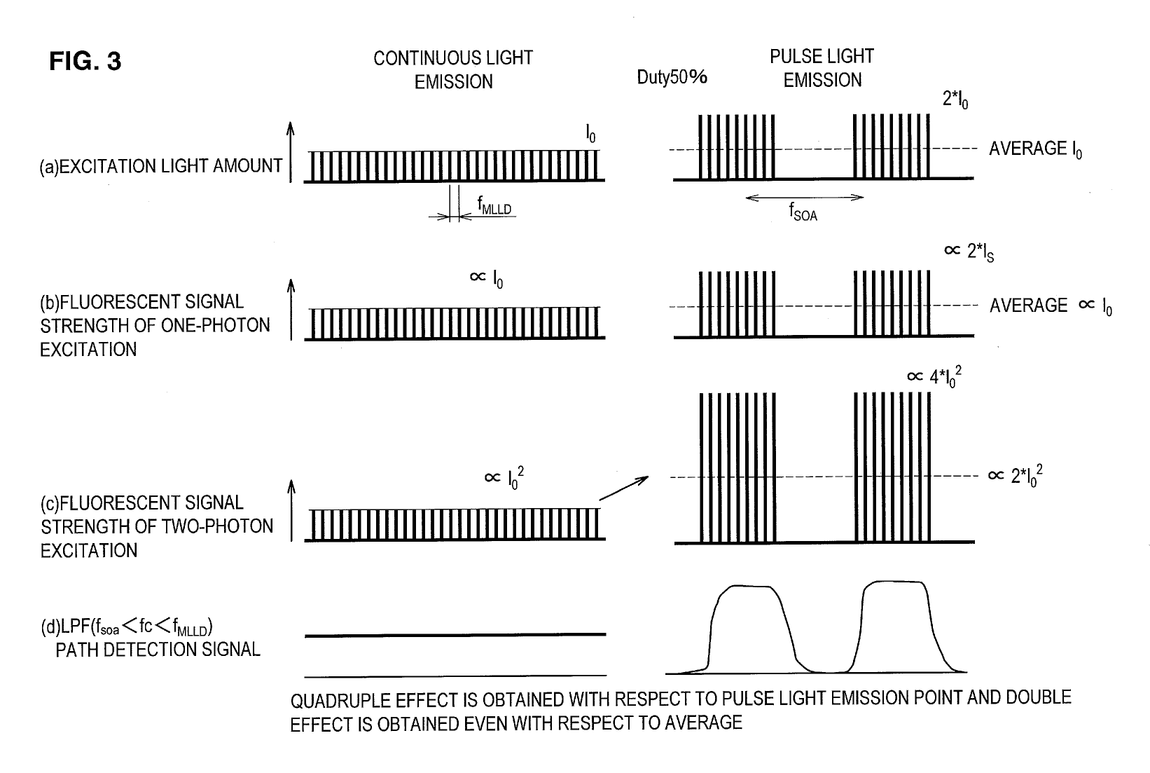

FIG. 3 is a diagram illustrating characteristics when the peak power of the laser is increased by intermittent light emission. In FIG. 3(a), the characteristics on the left side of the upper portion show peak power of continuous light emission and the characteristics on the right side thereof show peak power of intermittent light emission when the DUTY ratio is set to 50%. As illustrated in FIG. 3(b), in the case of one-photon excitation, a fluorescent signal intensity proportional to the peak power can be obtained. Therefore, when a DUTY ratio of the intermittent light emission is set to 50%, a signal intensity (∝2×I₀) which is double a signal intensity (∝I₀) of continuous light emission can be output in the case of the intermittent light emission.

FIG. 3(c) illustrates characteristics in the case of the two-photon excitation. The characteristics on the left side show the fluorescent signal intensity of the continuous light emission and the characteristics on the right side show the fluorescent signal intensity of the intermittent light emission when the DUTY ratio is set to 50%. The figure of merit FOM is increased by a square of the peak power in the case of the two-photon excitation. Accordingly, in the case of the intermittent light emission, a signal strength (proportional to 4×I₀²) of the two-photon excitation is four times a signal intensity (proportional I₀²) of the continuous light emission. Also, even in an average signal strength of a pulse light emission point and a pulse non-light emission point, an average signal strength (proportional 2×I₀²) of the two-photon excitation is twice the signal intensity (proportional I₀²) of the continuous light emission. Accordingly, in the embodiment, by performing the intermittent driving in the two-photon excitation light source 200, it is possible to increase the peak power and the average signal strength.

The characteristics of FIG. 3(d) show a signal obtained by passing the characteristics of the middle portion through a lowpass filter (a lowpass filter (LPF) 318) illustrated in FIG. 1) of the band limitation. A process performed by the lowpass filter of the band limitation is performed before A/D conversion. Therefore, when a duty ratio of ON/OFF is 50% (½), a signal amplitude before the A/D conversion becomes ½. Consequently, a double signal amplitude can be obtained in the intermittent light emission of the two-photon excitation. Also, when the duty ratio of ON/OFF is 1/n and the peak power becomes n times, the signal amplitude obtained by the two-photon excitation becomes n times. Therefore, the duty is preferably small. However, in practice, since there is the upper limit in the peak power obtained from the light source 200, it is appropriate to select an appropriate value equal to or less than 1 as the duty ratio. The light source 200 is not limited to the configuration of the MOPA 210 for two-photon excitation, but an embodiment of the present disclosure can also be applied to a microscope system of a one-photon excitation light source. For example, since an LD used as a light source for the one-photon excitation can also be used as an optical disc, intermittent light emission of ON and OFF can be performed in units of pixels.

### [1.3. Example of the Configuration of Microscope System]

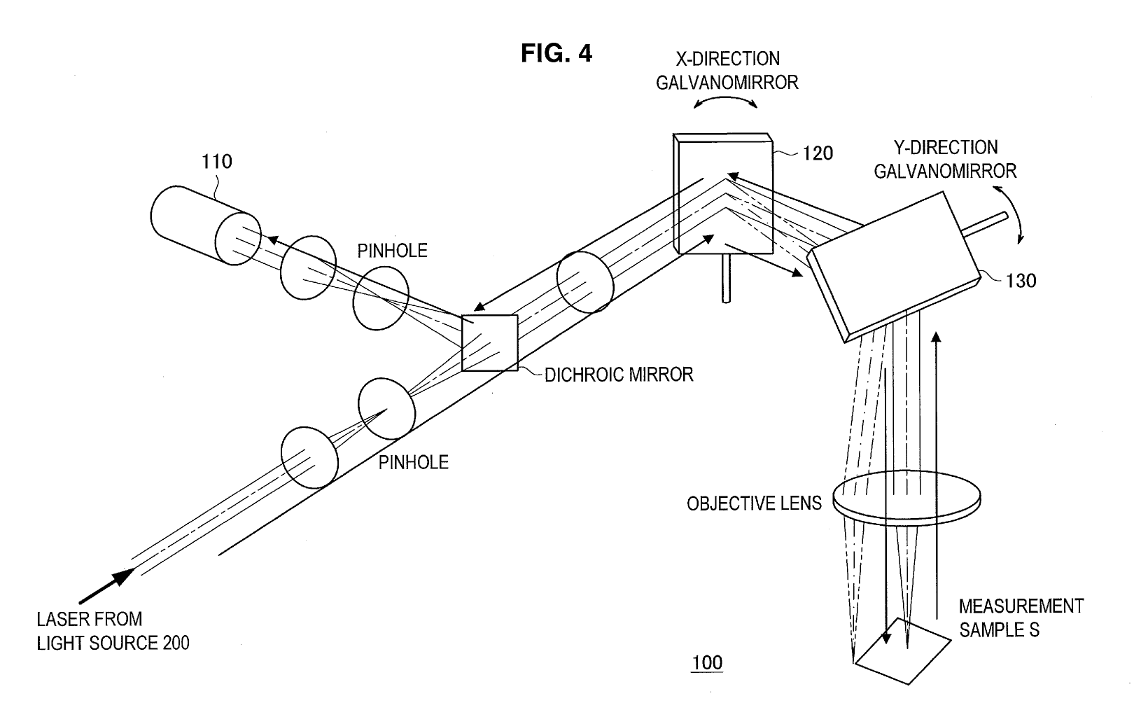

Next, the configuration of the microscope body 100 will be described with reference to FIG. 4. FIG. 4 illustrates an example of the configuration of a confocal fluorescence microscope using two kinds of galvanomirrors. The microscope body 100 performs beam scanning on the target sample S two-dimensionally by the two galvanomirrors.

Excitation light radiated from the light source 200 passes through pinholes that are installed in an optical system such as a lens and at a conjugated position, and subsequently passes through a dichroic mirror that passes excitation light and reflects fluorescence. The excitation light having passed through the dichroic mirror passes through an optical system such as a lens so that the X coordinate is controlled by an X-direction galvanomirror 120 that controls scanning in the X direction of the measurement sample and the Y coordinate is subsequently controlled by a Y-direction galvanomirror 130 that controls scanning in the Y direction, and then is condensed at desired XY coordinates on the measurement sample S by an objective lens.

The fluorescence emitted from the measurement sample is reflected by the Y-direction galvanomirror 130 and the X-direction galvanomirror 120, traces the same path as that of the excitation light, and is reflected by the dichroic mirror. The fluorescence reflected by the dichroic mirror passes through the pinhole installed at the conjugated position, and is subsequently guided to a detector 110 such as a photomultiplier tube (PMT).

Here, the rotation shafts of the two galvanomirrors used to control a condensing position on the measurement sample are connected to mirrors, as schematically illustrated in FIG. 4. In the galvanomirrors 120 and 130, rotation amounts of the rotation shafts are controlled according to the magnitude of an input voltage and angles at which the mirror surfaces face can be changed at a high speed and with high precision.

FIG. 4 illustrates the case of the one-photon excitation. In the case of the two-photon excitation, since it is not necessary to pass the light through the galvanomirrors and the pinholes, the fluorescence emitted from the measurement sample may be guided to the detector such as a photomultiplier tube (PMT) installed on the rear stage of the objective lens.

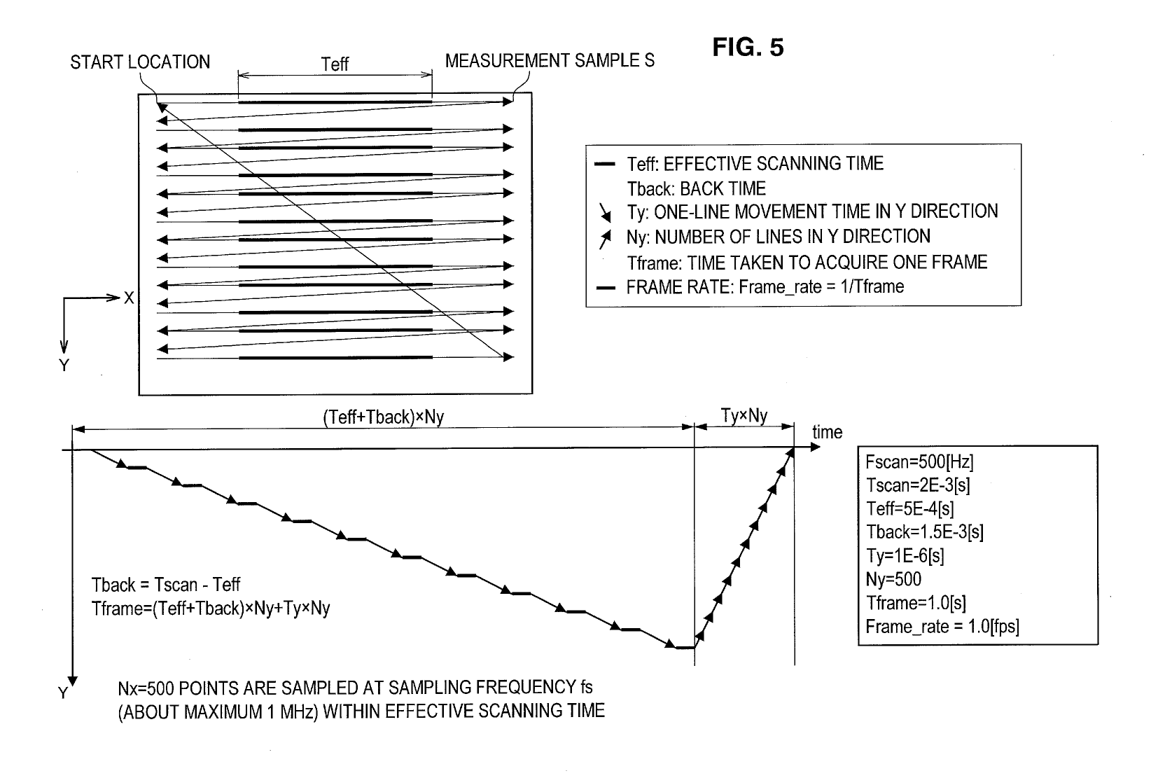

In the laser scanning microscope illustrated in FIG. 4, the ways in which excitation light moves when the XY plane of the measurement sample is scanned are different according to a combination of operation methods of the two galvanomirrors 120 and 130. Hereinafter, a method of generating a two-dimensional image using a raster scanning scheme which is the most general scanning scheme will be described with reference to FIG. 5. In the case of the raster scanning scheme, scanning is performed in the horizontal direction with the X-direction galvanomirror 120 and return light to the detector 110 is sampled at a central portion other than the returned vicinity to be set as image information.

In the following description, for example, on the sample plane of the measurement sample S on which the coordinate system illustrated in FIG. 5 is defined, an operation speed of the galvanomirror 120 controlling the scanning in the X direction is assumed to be faster than an operation speed of the galvanomirror 130 controlling the scanning in the Y direction.

The drawing illustrated in the upper portion of FIG. 5 schematically shows how the excitation light moves in the XY directions when the top left location of the sample plane is assumed to be a start point of the scanning.

In the raster scanning scheme, as shown on the sample plane of the measurement sample S in FIG. 5, detection of the fluorescence (acquisition of an image) is performed during a period in which the X-direction galvanomirror 120 is rotated so that the excitation light is moved in the X direction from the left end to the right end of the sample plane. In the raster scanning scheme, the Y-direction galvanomirror 130 stops during the period in which the X-direction galvanomirror 120 operates.

Basically, when the excitation light reaches up to the right end of the sample plane, the detection of the fluorescence is paused and the X-direction galvanomirror 120 changes a rotation angle of the rotation shaft up to a position corresponding to the left end. During this period, the Y-direction galvanomirror 130 moves a step in the Y axis positive direction by one line. When such an operation is repeated by the number of lines and the excitation light reaches up to the bottom right of the sample plane, the X-direction galvanomirror 120 and the Y-direction galvanomirror 130 return the position to the start position of the scanning by rotating each rotation shaft considerably so that one two-dimensional image (frame) is generated.

In such a raster scanning scheme, the Y-direction galvanomirror 130 stops while the X-direction galvanomirror 120 operates. Therefore, a shape of a unit (image formation unit) in which the generated two-dimensional image is formed is a rectangular shape illustrated in the upper portion of FIG. 5.

The graph illustrated in the lower portion of FIG. 5 is a timing chart showing how the Y coordinate changes over time. When T_{frame} is a time necessary to obtain a one-frame image, the time is expressed as in the following equation 11, as apparent from the timing chart in the lower portion of FIG. 5. Here, in the following equation 11, T_{scan} indicates a scanning period, N_{y} indicates the number of lines in the Y direction, and T_{Y}_{_{—}}ₐₗₗ indicates a return time in the Y direction.

T_{frame}=(T_{scan})×N_{y}+T_{Y}_{_{—}}ₐₗₗ (equation 11)

Here, the scanning period T_{scan}, an effective scanning time T_{eff}, and a back time T_{back} have a relation expressed in the following equation 12. When T_{y} is a one-line movement time in the Y direction, the return time T_{Y}_{_{—}}ₐₗₗ in the Y direction is expressed as in the following equation 13. Here, the back time T_{back} in the following equation 12 indicates a total time necessary for movement from the end of the effective scanning section (for example, a section indicated by a solid line in the X direction on the sample plane in the upper portion of FIG. 5) to the start of the effective scanning section of the subsequent period.

T_{eff}=T_{scan}−T_{back} (equation 12)

T_{Y}_{_{—}}ₐₗₗ=T_{y}×N_{y} (equation 13)

For example, a case in which the scanning frequency F_{scan} of the X-direction galvanomirror 120 is 7.8 kHz will be considered. In this case, the scanning period T_{scan} is expressed as a reciprocal of the scanning frequency F_{scan}, T_{scan}=1/F_{scan}=1.28×10⁻⁴ seconds. Also, when the effective scanning time T_{eff} of this galvanomirror is expressed as { scanning period T_{scan}×(⅓)} based on scanning efficiency, the effective scanning time is 4.27×10⁻⁵ seconds and the back time T_{back} is 1.28×10⁻⁴−4.27×10⁻⁵=8.53×10⁻⁵ seconds.

Also, when the return time Ty in the Y direction in the Y-direction galvanomirror 130 is 1×10⁻⁶ and the number of lines N_{y} in the Y direction is 512, the time T_{frame} necessary to photograph one frame is 6.62×10⁻² seconds from the foregoing equation 11. Since the frame rate is a value expressed as a reciprocal of T_{frame}, Frame-rate=15.1 (frame/s) in such a scanning system.

In the raster scanning scheme illustrated in FIG. 5, as shown in the sample plane in the upper portion of FIG. 5, in a period in which the X-direction galvanomirror 120 is rotated and the excitation light is moved in the X direction from the left end to the right end of the sample plane, the light source 200 is caused to emit light only during the effective scanning time T_{eff}. That is, in the round-trip scanning in the X direction, the light source 200 is turned on only during the effective scanning time T_{eff} in which the image is acquired and the light source is turned off during a period other than the effective scanning time T_{eff} and a direction change period. At this time, the ON/FF of the light source 200 is performed at a frequency in the range of about 50 Hz to about 10 kHz. Therefore, since the light is emitted periodically by causing the light source 200 to emit light only during the effective scanning time T_{eff} as well as the intermittent driving by the above-described pulse waveform P1, the average power of the laser can be lowered and the peak power can be increased.

Also, when the microscope body 100 is not in an image acquisition mode, the light source 200 is assumed to be turned off. At this time, the light source 200 may be turned off by turning off the optical amplifier unit 240, or the MLLD itself may be turned off.

### [1.4. Relation Between Sampling Period and Intermittent Light-Emission Period]

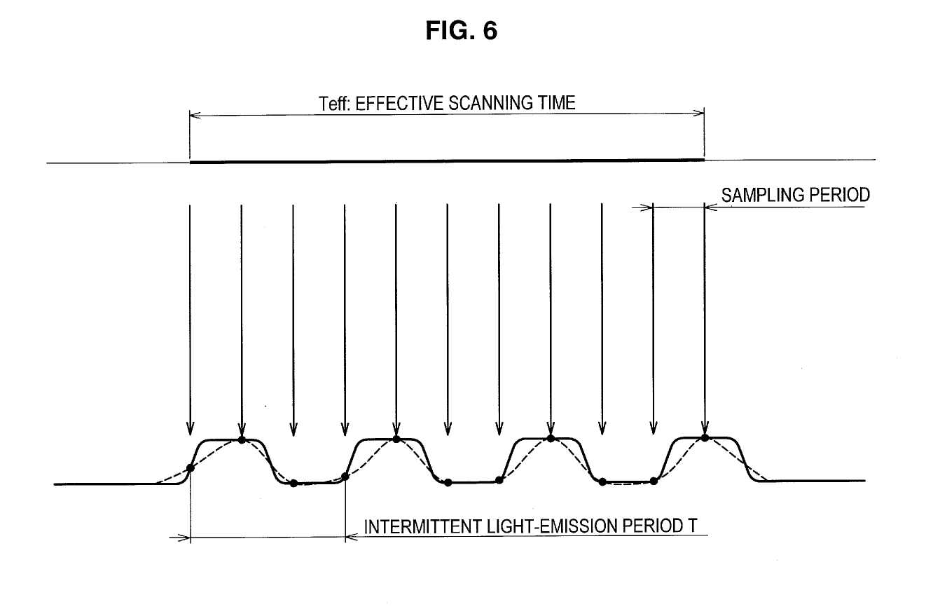

The detector 110 such as a photomultiplier tube (PMT) detecting photons is an analog element and photoelectrically converts introduced photons into an electric signal (a current value or a voltage value). The converted electric signal is subjected to A/D conversion at a predetermined sampling period. The signal subjected to the A/D conversion corresponds to one-pixel image information. FIGS. 6 to 8 are diagrams illustrating characteristics of the sampling period and an intermittent light-emission period T by the pulse waveform P1.

FIG. 6 illustrates a case in which the sampling period is shorter than the intermittent light-emission period T. In other words, FIG. 6 illustrates a case in which the sampling frequency is higher than the intermittent light-emission frequency. In the characteristics in the lower portion of FIG. 6, characteristics indicated by a solid line represent the electric signal after the photoelectric conversion performed by the detector 110 and a dashed line indicates the characteristics connecting the sampling values. In this case, since sampling is performed at a non-light-emission timing, that is, a non-excited timing, in some cases, an obtained image is an image (a patched pattern-like image, i.e., a so-called teeth-missing image), in which brightness and darkness alternate in adjacent pixels.

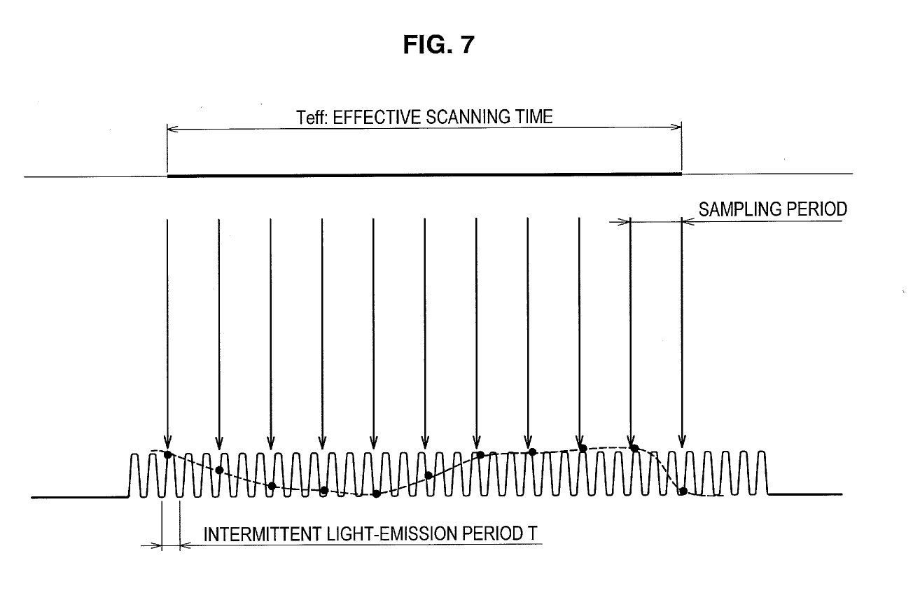

FIG. 7 illustrates a case in which the sampling period is longer than the intermittent light-emission period T. In other words, FIG. 7 illustrates a case in which the sampling frequency is lower than the intermittent light-emission frequency. As in FIG. 6, characteristics indicated by a solid line represent the electric signal after the photoelectric conversion performed by the detector 110 and a dashed line indicates the characteristics connecting the sampling values. In this case, the electric signal after the photoelectric conversion includes an electric signal with a frequency higher than the sampling frequency. Therefore, although the electric signal is originally a constant-level signal, various values are sampled, and thus a correct waveform may not be reproduced due to the influence of aliasing. Thus, when the sampling period and the intermittent light-emission period T are asynchronous, the signal level is not constant. Also, when the sampling period and the intermittent light-emission period T are synchronous, the original signal level is constant. However, in the asynchronous case, color deterioration occurs due to unnecessary excitation. When a biological object is observed, an adverse effect such as unnecessary excitation or extinction of cells or the like to be observed due to phototoxicity may also occur.

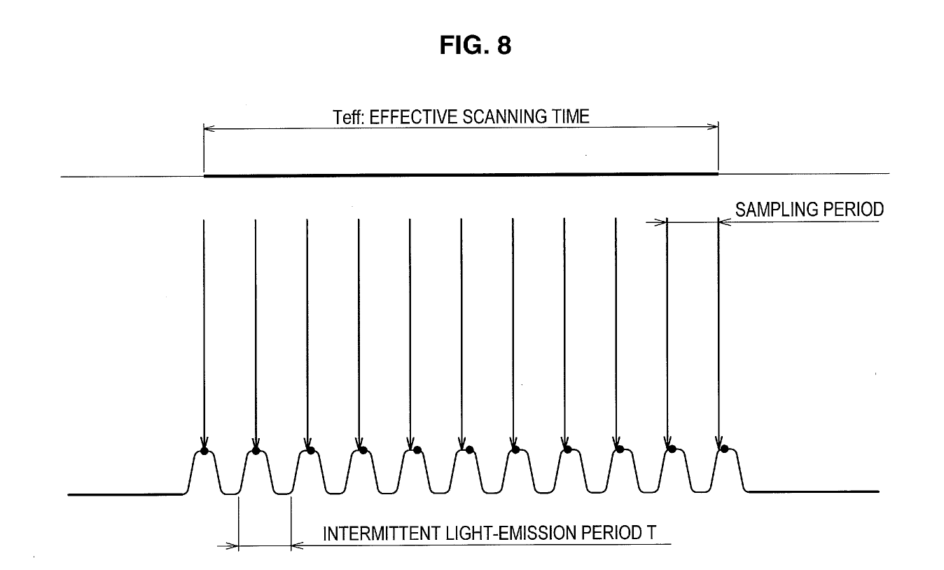

FIG. 8 illustrates a case in which the sampling period is caused to be identical to the intermittent light-emission period T. That is, FIG. 8 illustrates a case in which the sampling frequency is identical to the intermittent light-emission frequency. In FIG. 8, the phases are caused to be identical so that sampling is performed at the peak of the intermittent light-emission period T. Thus, when the sampling period is synchronized with the intermittent light-emission period T, a correct signal can be obtained and the color deterioration can also be suppressed to be as small as possible.

The sampling frequency fs is, for example, in the range of about 100 kHz to about 10 MHz. Basically, the sampling frequency fs is decided from the specification of the microscope system 1000 and the intermittent light-emission frequency is caused to be identical to the sampling frequency fs. On the other hand, the intermittent light-emission frequency may be first decided and the sampling frequency may be caused to be identical to the intermittent light-emission frequency.

Also, pulse light emission other than the above description, an ON/OFF signal of a scanning beam, or an ON/OFF signal of image acquisition are also preferably synchronized with the sampling period of the A/D conversion, but may not necessarily be synchronized.

To cause the sampling period to be identical to the intermittent light-emission period T, an ON/OFF period by the optical amplifier unit 240 in FIG. 1 is considered to be identical to the sampling period of the A/D conversion circuit that performs A/D conversion on the electric signal detected by the detector 110 such as a photomultiplier tube (PMT). That is, by inputting the same ON/OFF clock by the SOA driver 244 to the A/D conversion circuit without change, it is possible to cause the sampling period to be identical to the intermittent light-emission period T reliably. Thus, the frequencies and the phases related to the sampling and the intermittent light emission can be caused to be identical.

As described in FIG. 2, the laser beam L3 output from the wavelength conversion module 250 is emitted in a pulse shape within a light-emission period of the intermittent light emission. FIG. 8 illustrates light emission after the pulse is processed to the degree that the pulse is not seen by the lowpass filter (the lowpass filter 318 illustrated in FIG. 1). At this time, as will be described in detail below, the band limitation of the lowpass filter is preferably equal to or less than ½ of the sampling frequency. For example, when the sampling frequency is 1 MHz, the band limitation of the lowpass filter is set to a maximum of 500 kHz. In this way, it is possible to establish the Nyquist sampling theorem. Accordingly, phase deviation between the sampling period and the intermittent driving period is permitted.

[1.5. Example of Configuration in which Sampling Period is Caused to be Identical to Intermittent Driving Period]

Next, a configuration by which the sampling period and the intermittent driving period are caused to be identical will be described with reference to FIG. 1. As illustrated in FIG. 1, the control unit 300 is configured to include a timing generator 302, a sampling signal generation unit 304, an A/D conversion unit 306, a memory 308, a galvano-beam control unit 310, a D/A conversion unit 312, an intermittent light-emission signal generation unit 314, an oscillation synchronization signal injection unit 316, and the lowpass filter (LPF) 318.

As illustrated in FIG. 1, the timing generator 302 generates a clock CLK and the sampling signal generation unit 304 generates a sampling signal with the sampling frequency fs based on the clock CLK. Also, the intermittent light-emission signal generation unit 314 generates an intermittent light-emission signal with a period T for intermittent light emission based on the clock CLK. Thus, the sampling signal generated by the sampling signal generation unit 340 and the intermittent light-emission signal generated by the intermittent light-emission signal generation unit 314 can be caused to be synchronized. For example, when the sampling signal generation unit 304 uses the clock CLK as the sampling frequency fs without change and the intermittent light-emission signal generation unit 314 uses the clock CLK as the frequency of the intermittent light-emission signal without change, the sampling period and the intermittent light-emission period T become identical.

The electric signal obtained through the photoelectric conversion by the detector 110 is input to the lowpass filter 318. The lowpass filter 318 performs the band limitation on the input signal so that the Nyquist sampling theorem is established, as described above, and outputs the signal to the A/D conversion unit 306. The A/D conversion unit 306 performs the A/D conversion on the input signal at the sampling frequency fs. The SOA driver 244 turns the laser beam (the pulse waveform L1) on and off at the frequency of the intermittent light-emission signal and outputs the intermittent laser beam (the pulse waveform L2).

Also, the galvano-beam control unit 310 receives an input of the clock signal CLK from the timing generator 302 and generates a galvanomirror control signal to control the galvanomirrors 120 and 130. The galvanomirror control signal is subjected to D/A conversion by the D/A conversion unit 312, and the galvanomirrors 120 and 130 are controlled by the galvanomirror control signal subjected to the D/A conversion. Thus, the galvanomirrors 120 and 130 can also be controlled based on the clock CLK. As described above, in the raster scanning scheme, the light source 200 is caused to emit light only during the effective scanning time T_{eff}. Therefore, the intermittent light-emission signal generation unit 314 generates the intermittent light-emission signal only during the effective scanning time T_{eff} of the raster scanning based on the clock CLK and turns the intermittent light-emission signal off during a time other than the effective scanning time T_{eff}. Likewise, the sampling signal generation unit 304 generates the sampling signal only during the effective scanning time T_{eff} based on the clock CLK. Accordingly, the sampling signal and the intermittent light-emission signal become synchronized at an operation period of the galvanomirrors. Thus, by turning the sampling signal and the intermittent light-emission signal off during a time other than the effective scanning time T_{eff}, the average power can be lowered and the peak power can thus be increased.

### [1.6. Configuration of Lowpass Filter]

The lowpass filter 318 installed on the front stage of the A/D conversion unit 306 performs the band limitation on an output of the detector (PMT) 110 to a frequency satisfying the Nyquist sampling theorem. More specifically, the lowpass filter 318 performs the band limitation of the output of the detector 110 to a frequency of ½ to ⅓ of the sampling frequency. For example, when the sampling frequency is 1 GHz, the output of the detector 110 is subjected to the band limitation to about 300 kHz to about 500 kHz. When the sampling frequency is variable, the band of the lowpass filter 318 is also changed in proportion to the sampling frequency.

By performing the band limitation on the output of the detector 110 to a frequency satisfying the Nyquist sampling theorem, it is possible to prevent an unnecessary signal from being included in a sampling result reliably and thus to improve reproduction of an image reliably.

### [1.7. Synchronization Between Oscillation Optical Pulse of Laser Beam and Modulation of Laser Beam]

Next, a relation between an oscillation optical pulse of a laser beam and the period of an intermittent light-emission signal will be described. In the embodiment, the oscillation optical pulse of the laser beam can also be synchronized with the clock CLK of the timing generator 302.

The oscillation frequency of the laser beam radiated from the mode-locked laser unit 220 is decided by the speed of light and the path length of the external resonator described above. The signal injected from the timing generator 302 is also considered to have almost the same as the frequency as the frequency of the resonator. However, by providing phase information which the system has through the injection of the transmission synchronization signal from the oscillation synchronization signal injection unit 316, it is possible to synchronize the phase information which the system has with the external resonator.

Therefore, the oscillation synchronization signal injection unit 316 sends the oscillation synchronization signal synchronized with the clock CLK to a capacitor of a bias Tee based on the clock signal CLK of the timing generator 302. The oscillation synchronization signal is supplied as an AC component of a gain current Ig for the semiconductor laser 222.

Since the oscillation synchronization signal synchronized with the clock CLK is supplied as the AC component of the gain current Ig for the semiconductor laser 222, the oscillation optical pulse of the laser beam radiated from the semiconductor laser 222 can be synchronized with the clock CLK.

As described above, the oscillation synchronization signal injection unit 316 supplies the semiconductor laser 222 with the oscillation synchronization signal synchronized with the clock CLK. Thus, it is possible to synchronize the oscillation optical pulse of the laser beam radiated from the semiconductor laser 222 with the clock CLK.

As described above, the intermittent light-emission signal generation unit 314 generates the intermittent light-emission signal for the intermittent light emission based on the clock CLK and drives the optical amplifier unit 240 using the intermittent light-emission signal, the optical amplifier unit 240 is turned on and off to be driven in synchronization with the clock CLK and the laser beam is modulated in synchronization with the clock CLK. Accordingly, it is possible to synchronize the oscillation optical pulse of the laser beam radiated from the semiconductor laser 222 with the modulation of the laser beam. Thus, even when the laser beam has a considerably high pulse optical frequency, it is possible to easily synchronize the oscillation optical pulse of the laser beam with the modulation of the laser beam and thus to acquire a desired image.

Also, the synchronization of the oscillation optical pulse of the laser beam by the oscillation synchronization signal injection unit 316 is optional, and the synchronization may not be performed. In particular, when the period of the oscillation optical pulse of the laser beam and the period of the intermittent light-emission signal are considerably different, a desired image can be acquired without performing the synchronization.

### [1.8. Relation Between Optical Resolution and Sampling Frequency]

The resolution of a laser scanning microscope is decided by an optical resolution proportional to a wavelength λ [m] of an excitation light source. The optical resolution do is estimated to be λ/2 or 0.61*λ. However, for simplicity, when λ/2 is used, the optical resolution do=500 nm in the case of “λ=1000 nm.” When there is no limitation on the band of a photoelectric conversion element, an electric resolution de is decided by a beam speed v [m/s] and the sampling frequency fs [ 1/s].

In the electric resolution de, the sampling interval [m]=½ of v/fs by the Nyquist sampling theorem, and thus, the electric resolution “de=v/(2*fs)” can be calculated.

The beam speed v [m/s] can be calculated from a reciprocation frequency of the scanning beam and a scanning range. Therefore, when the calculation is performed based on the reciprocation frequency of 500 Hz and the scanning range of 1 mm as representative numbers, “v=1 [m/s]” is obtained by scanning the range of 1 mm at 1 ms which is half of the period of 2 ms.

As a result, the electric resolution de becomes “de=1 [m/s]/(2*1E+6[½])=500 nm” at “fs=1 MHz,” and thus is identical to the optical resolution do.

As described above, even when the beam speed is caused to be 10 times faster, 10 MHz suffices for the sampling frequency and it can be understood that there is no advantage from causing the sampling frequency to be any faster. Accordingly, in Japanese Patent No. 5007092, it is difficult to obtain the advantages described in the embodiment. Even when high-speed sampling is performed in synchronization with the pulse light emission, the resolution is not improved and it is also difficult to increase a signal amount.

As described above, by intermittently emitting the laser beam from the light source 200, the period of the intermittent light emission is configured to be identical to the sampling period of the electric signal of the image obtained from the detector 110. Thus, it is possible to reliably prevent a patched pattern-like image, i.e., a teeth-missing image, from being acquired. Also, it is possible to reliably prevent a correct waveform from not being reproduced due to the influence of aliasing. Further, since the unnecessary excitation of the laser beam can be suppressed, it is also possible to prevent an adverse effect such as extinction of cells or the like to be observed due to phototoxicity.

### 2. Second Embodiment

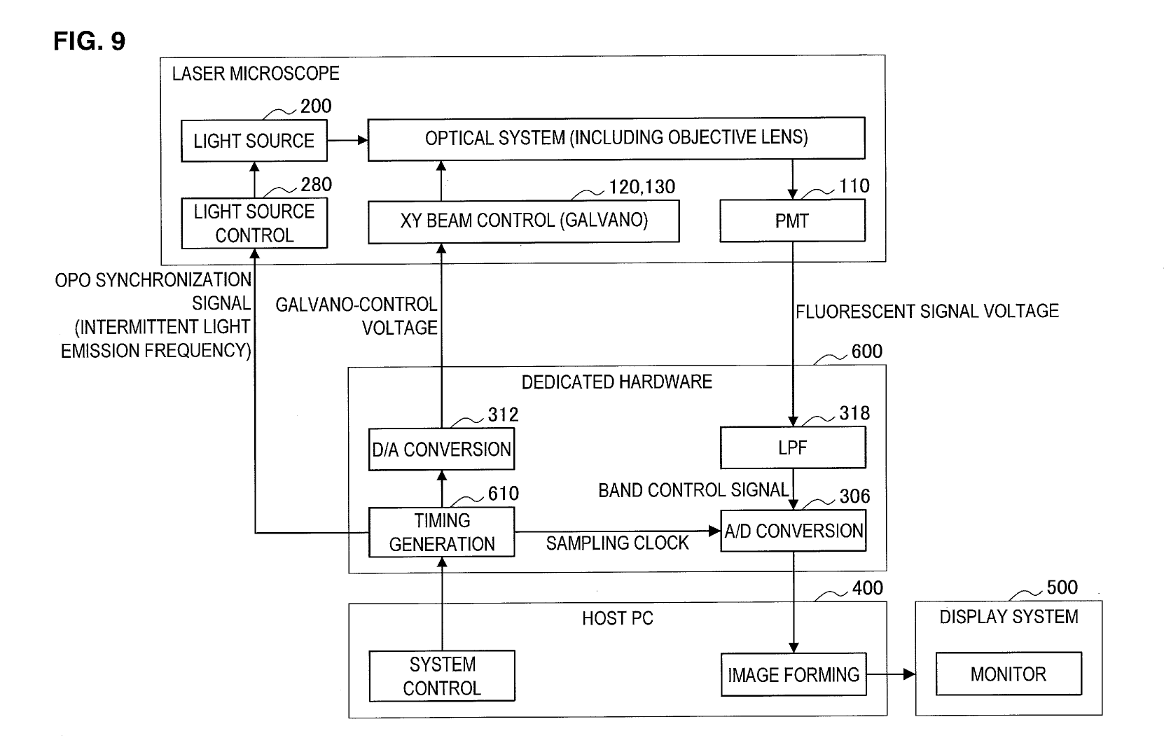

Next, a second embodiment of the present disclosure will be described. FIG. 9 is a schematic diagram illustrating an example of a configuration in which a host personal computer (PC) 400 and a monitor 500 are added to the system illustrated in FIG. 1. The host PC 400 is configured to include a system control unit 410 and a display control unit 420. In FIG. 9, dedicated hardware 600 corresponds to the control unit 300 in FIG. 1 and a timing generation unit 610 corresponds to the timing generator 302, the sampling signal generation unit 304, the galvano-beam control unit 310, and the intermittent light-emission signal generation unit 314 in FIG. 1. In FIG. 9, a light source control unit 280 corresponds to the SOA drive circuit 244 in FIG. 1.

The system control unit 410 of the host PC 400 instructs the timing generation unit 610 to generate a timing signal serving as a criterion. The timing signal serving as the criterion and generated by the timing generation unit 610 is transmitted to each of the light source control unit 280, an A/D conversion unit 306, and a D/A conversion unit 312. Thus, as described above, a sampling period in the A/D conversion unit 306 is identical to an intermittent light-emission period of a light source 200. A sampling result by the A/D conversion unit 306 is transmitted to the display control unit 420 of the host PC 400 so that image forming is performed for display on the monitor 500.

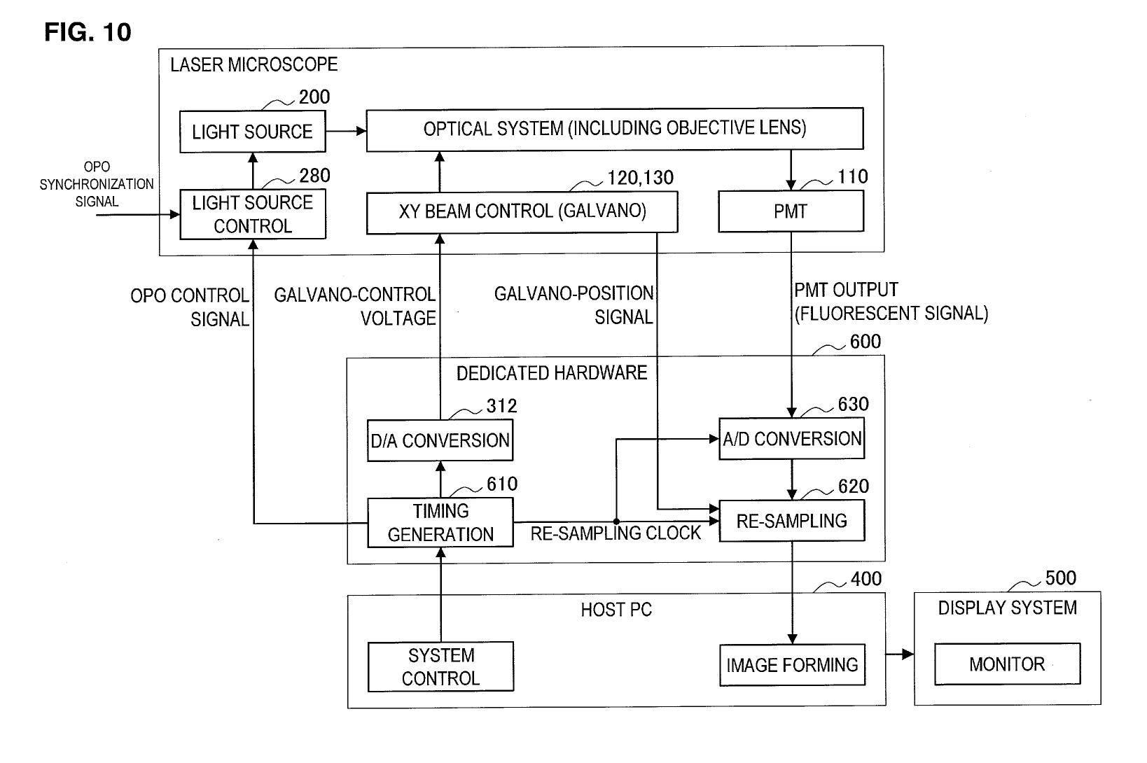

FIG. 10 is a schematic diagram illustrating a system performing high-speed sampling in FIG. 9. In the configuration illustrated in FIG. 10, a frequency sufficiently higher than the band of a PMT output is assumed to be used as a sampling clock of high-speed sampling. An A/D conversion unit 630 converts the output from the PMT 110 into digital data using the sampling clock of the high-speed sampling. The timing generation unit 610 transmits a re-sampling clock signal to the re-sampling unit 620. The re-sampling unit 620 re-samples the digital data from the digital data sampled at a high speed and a galvano-position signal to form an image so that pixels on a sample are arranged at the same interval.

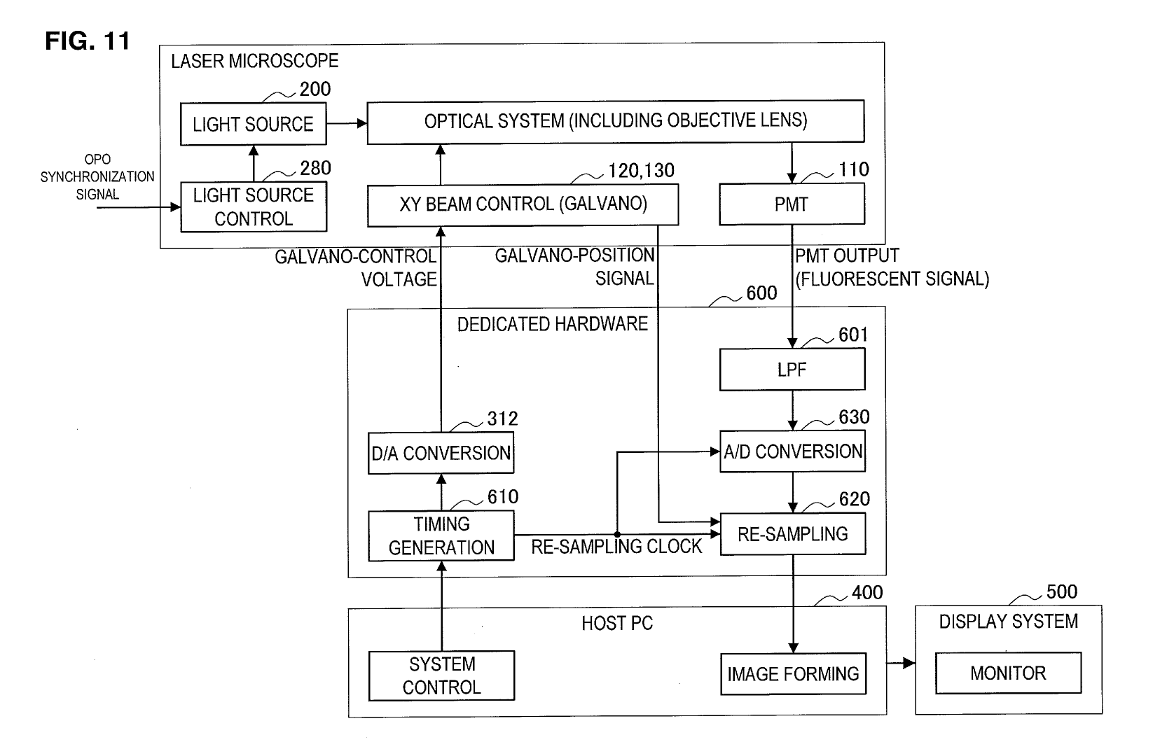

FIG. 11 is a schematic diagram illustrating a configuration in which intermittent light emission by the light source control unit 280 is performed asynchronously with a sampling clock in FIG. 10. In the configuration illustrated in FIG. 11, an analog lowpass filter (LPF) 601 is added to the front stage of the A/D conversion unit 630 in the configuration of FIG. 10. The LPF 601 has a band of ½ of an intermittent light-emission frequency fc. Even in such an asynchronous system, by adding the LPF 601 to the front stage of the A/D conversion unit 630, it is possible to suppress deterioration in image quality to be as small as possible.

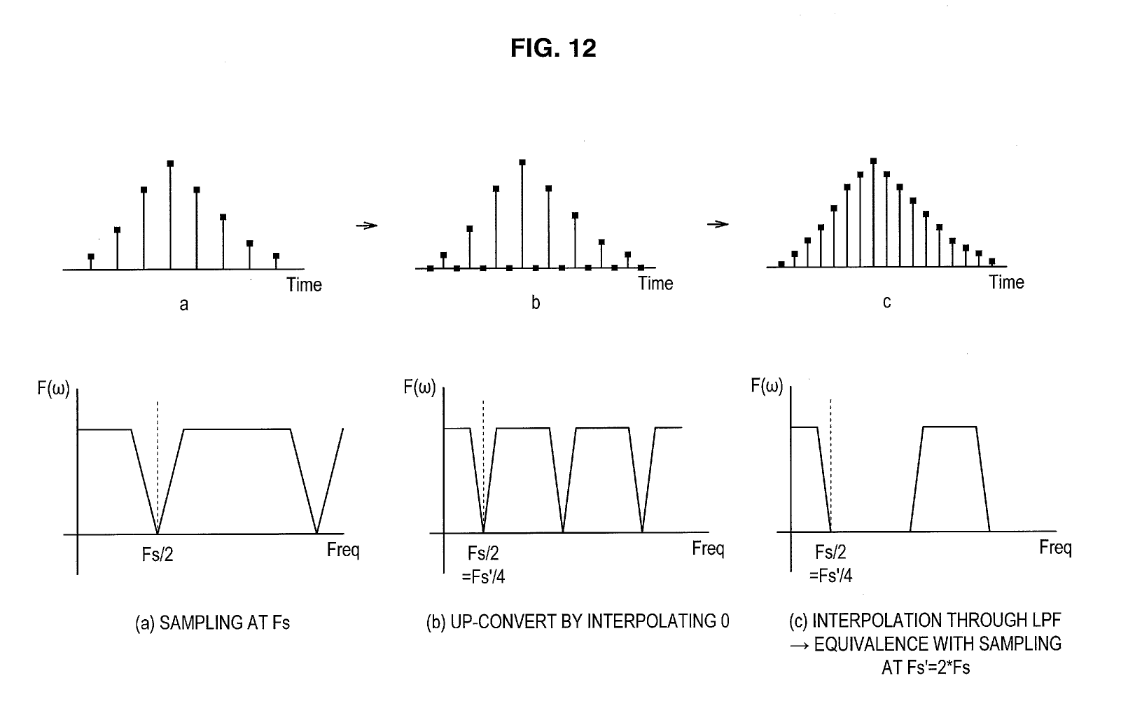

FIG. 12 is a schematic diagram illustrating an interpolation process in the re-sampling unit 620. First, sampling is performed at a frequency Fs of the high-speed sampling, as illustrated in FIG. 12(a), and then “0” is interpolated between sampling values for up-conversion, as illustrated in FIG. 12(b). Then, as illustrated in FIG. 12(c), by performing the interpolation through the lowpass filter (LPF), equivalence with sampling at Fs′=2*Fs is realized.

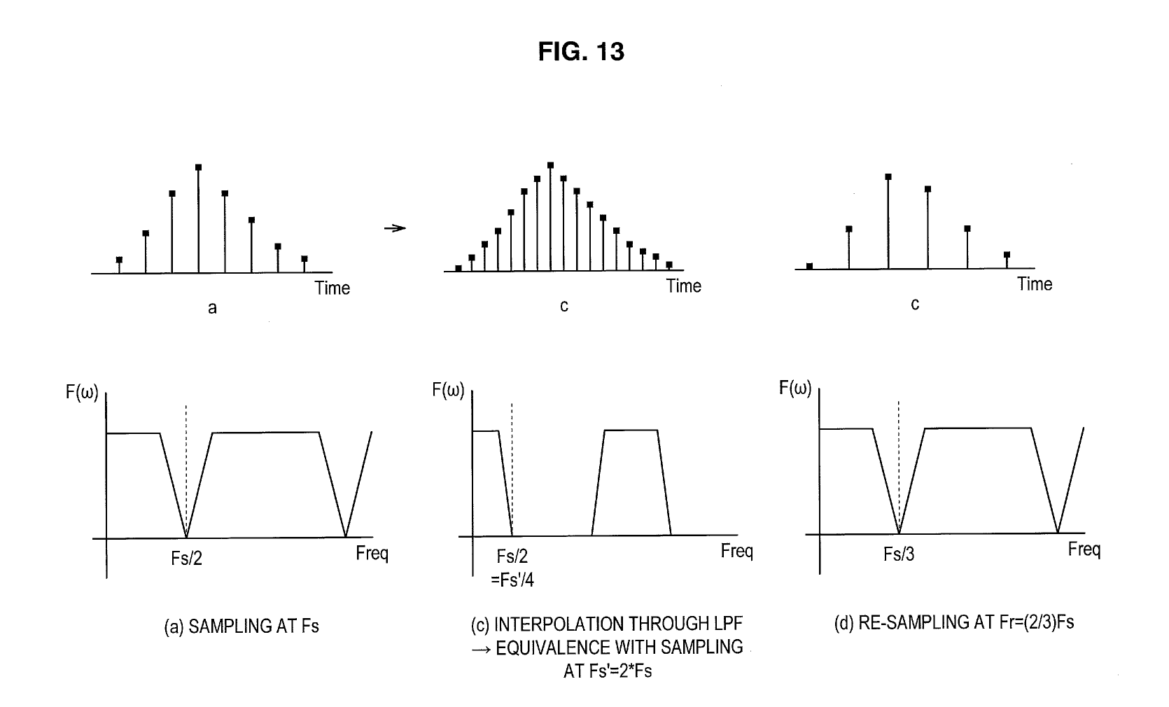

FIG. 13 is a schematic diagram illustrating a process in the re-sampling unit 620. First, sampling is performed at the frequency Fs, as illustrated in FIG. 13(a), and interpolation is performed through the lowpass filter (LPF), as illustrated in FIG. 13(b).

Thus, as illustrated in FIG. 12, equivalence with sampling at Fs′=2*Fs is realized. Then, as illustrated in FIG. 13(c), re-sampling is performed at Fr=(⅔)Fs. In this way, the up-conversion is performed at twice the original sampling frequency Fs, and then a value obtained through the sampling at Fr=(⅔)Fs can be obtained when the re-sampling is performed at intervals of 3. When the digital data sampled at the high speed is re-sampled, band limitation is first performed through the lowpass filter (LPF), and then a signal at the position of a re-sampling clock is calculated.

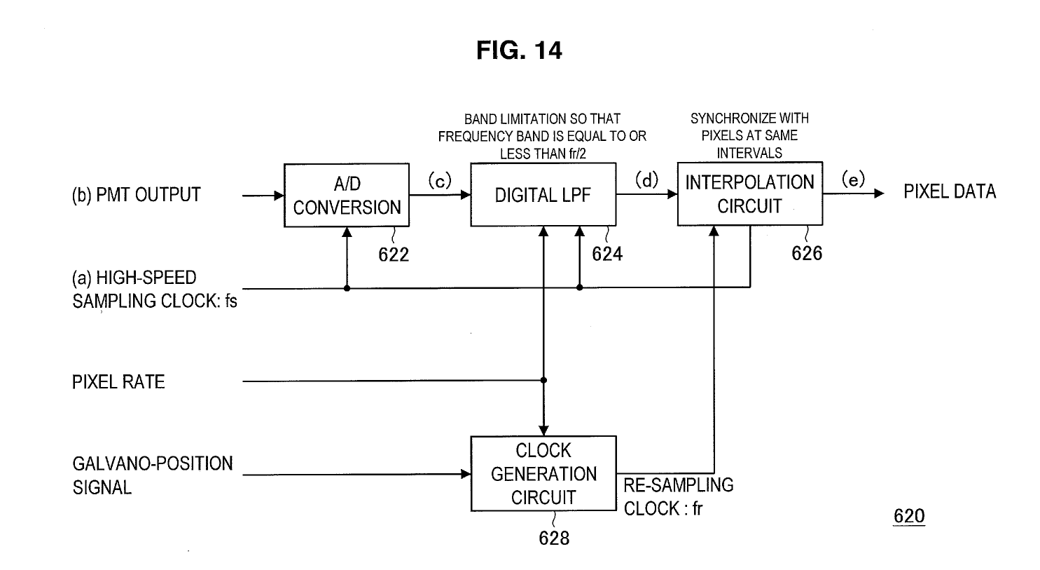

FIG. 14 is a schematic diagram illustrating the configuration of the re-sampling unit 620. In FIG. 14, the A/D conversion unit 630 is included in the re-sampling unit 620 and the function of an A/D conversion unit 622 is the same as that of the A/D conversion unit 630. As illustrated in FIG. 14, the re-sampling unit 620 includes the A/D conversion unit 622, a digital LPF 624, an interpolation circuit 626, and a clock generation circuit 628. A high-speed sampling clock Fs is input to the A/D conversion unit 622, the digital LPF 624, and the interpolation circuit 626. A pixel rate is input to the digital LPF 624 and the clock generation circuit 628. A galvano-position signal is also input to the clock generation circuit 628. The clock generation circuit 628 generates a re-sampling clock Fr based on the pixel rate and the galvano-position signal and transmits the re-sampling clock Fr to the interpolation circuit 626.

An output signal transmitted from the detector 110 such as a photomultiplier tube (PMT) is sampled at the high-speed sampling clock Fs to be converted into a digital signal by the A/D conversion unit 622. The digital signal is subjected to band limitation so that the frequency band is a frequency equal to or less than Fr/2 in the digital LPF 624. The signal subjected to the band limitation is transmitted to the interpolation circuit 626 and is re-sampled at Fr=(⅔)Fs, and the signal synchronized with the pixels at the same intervals is subjected to an interpolation process. The signal subjected to the interpolation process is output as pixel data.

The digital LPF 624 is assumed to change a pass-band according to a pixel rate. By passing the data subjected to high-speed A/D conversion by the A/D conversion unit 622 through the digital LPF 624, the data is subjected to the band limitation so that the frequency band is equal to or less than ½ of the pixel rate. The pixel rate is set as a numerical value. The interpolation circuit 626 performs interpolation calculation from surrounding data according to a timing of the re-sampling clock to calculate a signal at a pixel position. A range of galvano linear operation may be cut to perform equal sampling without performing the interpolation process based on the galvano-position signal.

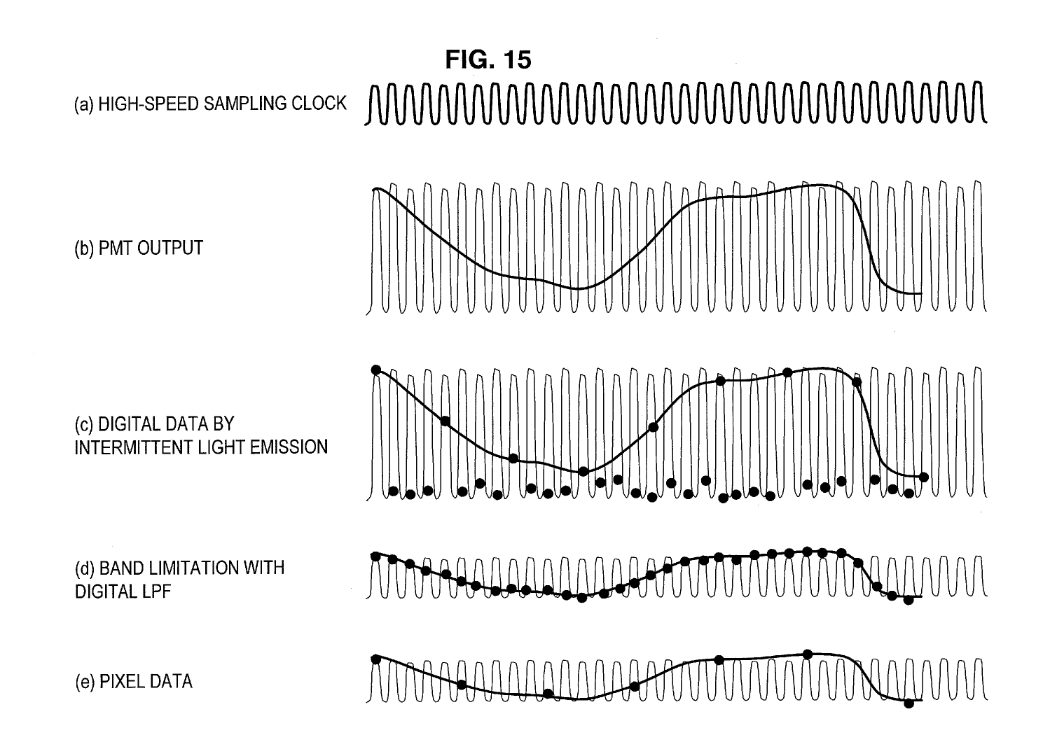

FIG. 15 is a schematic diagram illustrating waveforms processed by the re-sampling unit 620 in the system illustrated in FIG. 14. FIG. 15 illustrates (a) a high-speed sampling clock, (b) a PMT output, (c) digital data by intermittent light emission, (d) a signal subjected to band limitation by the digital LPF 624, and (e) pixel data. The signals of (a) to (e) of FIG. 15 correspond to the signals of (a) to (e) of FIG. 14. As illustrated in FIG. 15, a sampling clock of the high-speed sampling by the A/D conversion unit 622 is about four times an intermittent light-emission period. The sampling clock is identical to the PMT output once every 4 times of the sampling, but the sampling at timings of non-light emission is performed 3 times every 4 times. Therefore, the digital data after the A/D conversion by the A/D conversion unit 622 includes data obtained when the light source 200 emits no light. Accordingly, for the data (d) after the band limitation by the digital LPF 624 and the pixel data (e), an amplitude decreases and an influence of noise increases. This is because the data sampled at the timing of non-light emission becomes a noise component.

Therefore, in the embodiment, a process of suppressing the influence of the noise to be as small as possible is performed by acquiring (c) the digital data by the intermittent light emission illustrated in FIGS. 14 and 15 and setting “0” as the value of the digital data except for the digital data sampled at the sampling period by the intermittent light emission. First, an image acquisition range and a frame rate are set as prerequisites so that an optical frequency band f₀ determined from NA of the objective lens of the microscope body 100, a wavelength of an excitation light source, and a beam speed becomes ½ or less of the intermittent light-emission frequency fc. Thus, when the sampling is performed at the frequency fc, the Nyquist sampling theorem is satisfied.

The digital data sampled asynchronously at a high speed at the sample frequency fs in the A/D conversion unit 622 passes through the digital LPF 624 that performs the band limitation so that the frequency band is a frequency fp equal to or less than ½ of the re-sampling frequency fr. Then, the re-sampling is performed at a frequency fr (where fr>2*fp) equal to or less than fc. At this time, a signal output proportional to FOM=Ip*Ia can be obtained. Here, IP (W) is peak power of an OPO, Ia (W) is average power of the OPO, and Dt is an intermittent light-emission duty. Further, Ia=Pw*Fr*Ip*Dt is set, where Pw(s) is a pulse width and Fr(1/s) is a repetition frequency.

From the above description, it can be understood that the output decreases in proportion to the intermittent light-emission duty, but synchronization is not necessary.

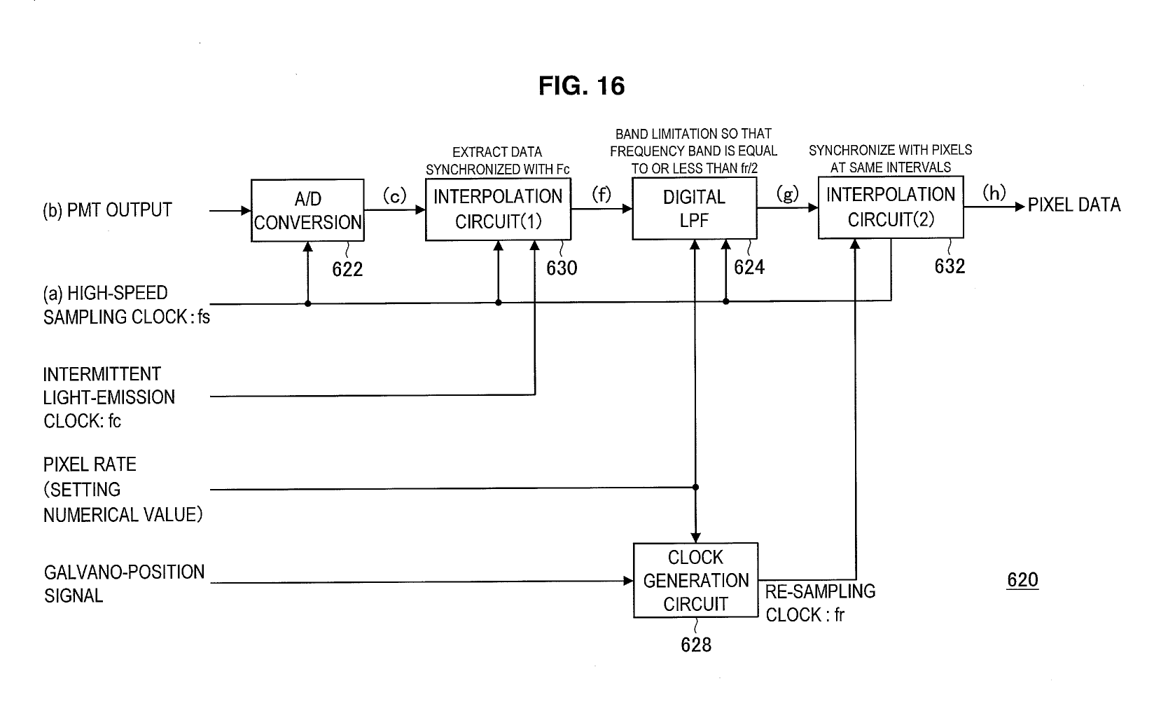

In the embodiment, in the A/D conversion unit 622 at the front stage of the digital LPF 624 in FIG. 14, an SNR (S/N ratio) equivalent to synchronous sampling is realized by extracting only a synchronous fluorescent signal. FIG. 16 is a schematic diagram illustrating the configuration of a synchronous re-sampling circuit. The synchronous re-sampling circuit (the re-sampling unit 620) illustrated in FIG. 16 includes two interpolation circuits 630 and 632 in the configuration of FIG. 14. The high-speed sampling clock Fs is input to the A/D conversion unit 622, the interpolation circuit 630, the digital LPF 624, and the interpolation circuit 632. The pixel rate is input to the digital LPF 624 and the clock generation circuit 628. The galvano-position signal is input to the clock generation circuit 628. The intermittent light-emission clock Fc is input to the interpolation circuit 630. As in FIG. 14, the clock generation circuit 628 generates a re-sampling clock Fr and transmits the re-sampling clock Fr to the interpolation circuit 632.

The interpolation circuit 630 generates digital data synchronized with the intermittent light-emission clock Fc. The synchronous clock Fc may be input from the outside or may be generated internally by a digital PLL (D-PLL). The digital LPF 624 is assumed to change a pass-band according to the pixel rate. The data subjected to the high-speed A/D conversion passes through the digital LPF 624 and is subjected to the band limitation so that the frequency band is equal to or less than ½ of the pixel rate. The interpolation circuit 632 performs interpolation calculation from surrounding data according to a timing of the re-sampling clock Fr to calculate a signal at a pixel position.

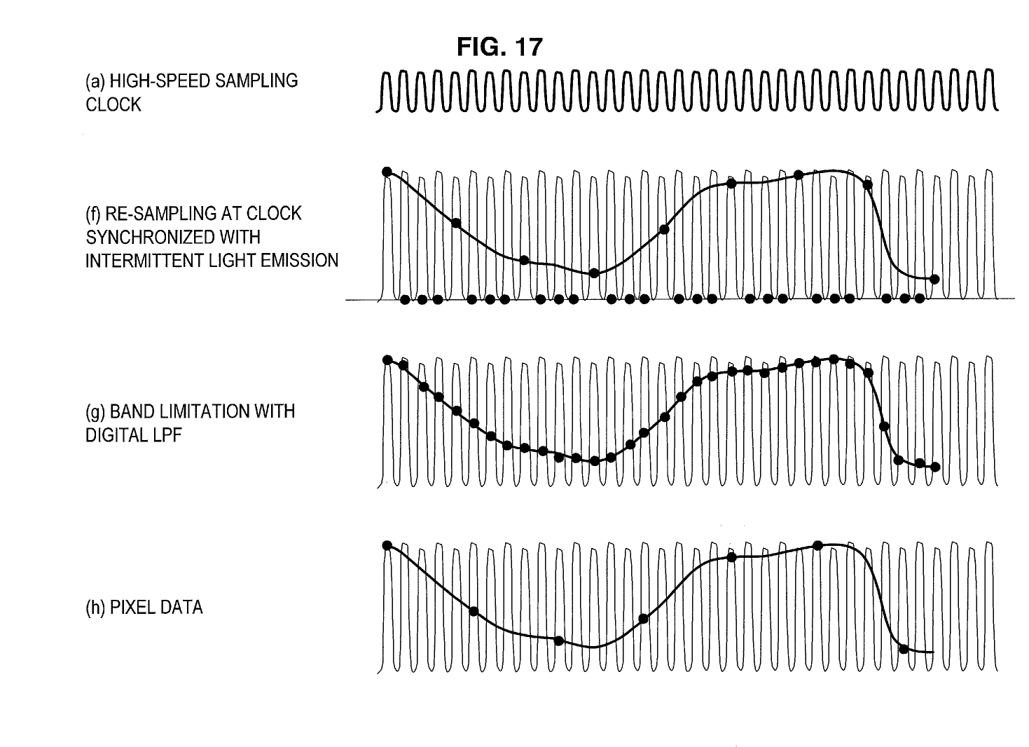

FIG. 17 is a schematic diagram illustrating waveforms processed by the re-sampling unit 620 having the configuration illustrated in FIG. 16. FIG. 17 illustrates (a) a high-speed sampling clock, (f) a state re-sampled at a clock Fc synchronized with intermittent light emission, (g) a state of band limitation by the digital LPF, and (h) pixel data. Here, (a), (f), (g), and (h) of FIG. 17 correspond to the signals of (a), (f), (g), and (h) of FIG. 16. As illustrated in (f) of FIG. 17, a value is considered to be “0” except for a value sampled at the clock Fc synchronized with the intermittent light emission by the interpolation circuit 630. Thus, since data at the time of no light emission of the light source 200 is not used, the value is considered to be “0” except for the value sampled at the lock Fc synchronized with the intermittent light emission in an amplitude after the band limitation by the digital LPF 624 unlike FIG. 15. Therefore, noise is not contained.

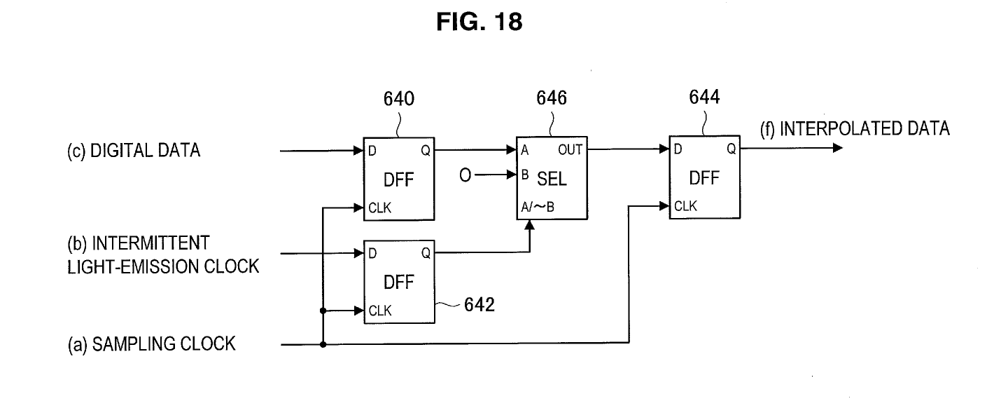

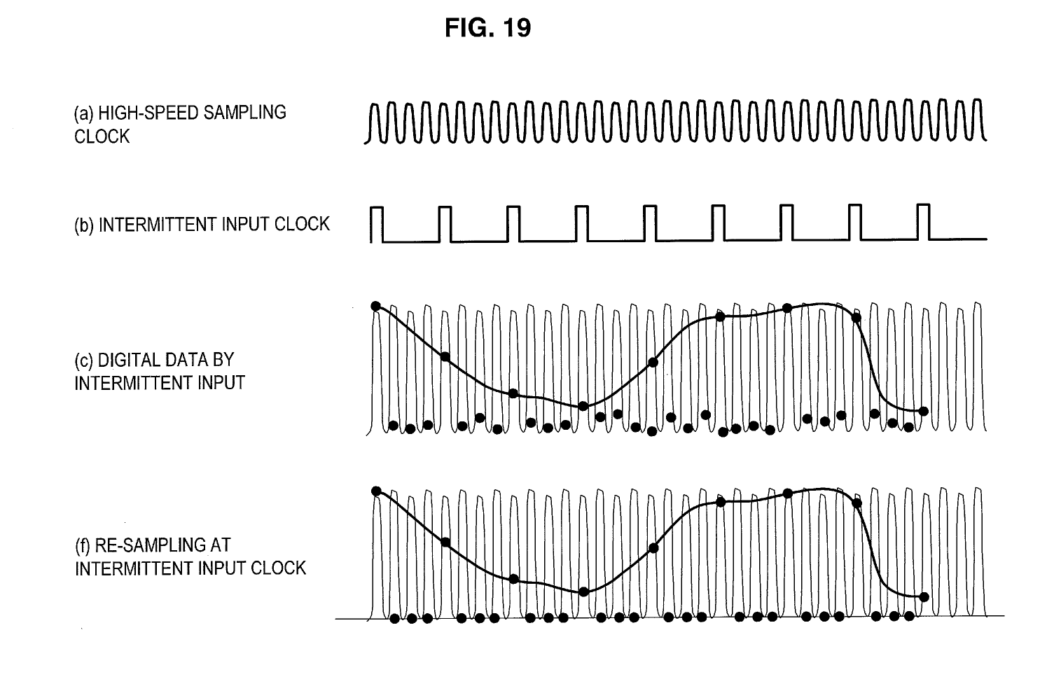

FIG. 18 is a schematic diagram illustrating the configuration of the interpolation circuit 630 illustrated in FIG. 16. As illustrated in FIG. 18, the interpolation circuit 630 includes a DEF 640, a DEF 642, a DEF 644, and an SEL 646. FIG. 19 is a schematic diagram illustrating signals input to the interpolation circuit 630. FIG. 19 illustrates (a) a high-speed sampling clock, (b) an intermittent light-emission clock, (c) digital data by intermittent input, and (f) a state re-sampled at a clock Fc synchronized with the intermittent light emission. Here, (a), (b), (c), and (f) of FIG. 19 correspond to the signals of (a), (b), (c), and (f) of FIGS. 16 and 18.

As illustrated in FIG. 18, (a) the high-speed sampling clock is input to the DEF 640, the DEF 642, and the DEF 644. Further, (b) the intermittent light-emission clock is input to the DEF 642. When the DEF 642 receives the input of (b) the intermittent light-emission clock, the DEF 642 outputs a latch signal to the SEL 646. The digital data by the intermittent input of (c) is transmitted from the DEF 640 to the SEL 646. The SEL 646 replaces the digital data by the intermittent input of (c) at the timing at which the latch signal is received with “0” and outputs “0” to the DEF 644. That is, a gate of the SEL 646 is formed by the latch signal. When the gate is turned on, data from the DEF 640 is output to the DEF 644. When the gate is turned off, “0” is output to the DEF 644. Thus, a signal re-sampled at the clock Fc synchronized with (f) the intermittent light emission is output from the DEF 644.

As illustrated in FIG. 15, the digital data (c) sampled at a high speed by the A/D conversion unit 622 includes the data at the time of no light emission of the light source 200. In the configuration illustrated in FIG. 18, the SEL 646 can set the data at the time of no light emission of the light source 200 to “0” by replacing the digital data by the intermittent input of (c) at the timing at which the latch signal is received with “0.” Accordingly, since the value is considered to be “0” except for the value sampled at the clock Fc synchronized with the intermittent light emission, it is possible to prevent noise from being contained in the digital data sampled at a high speed.

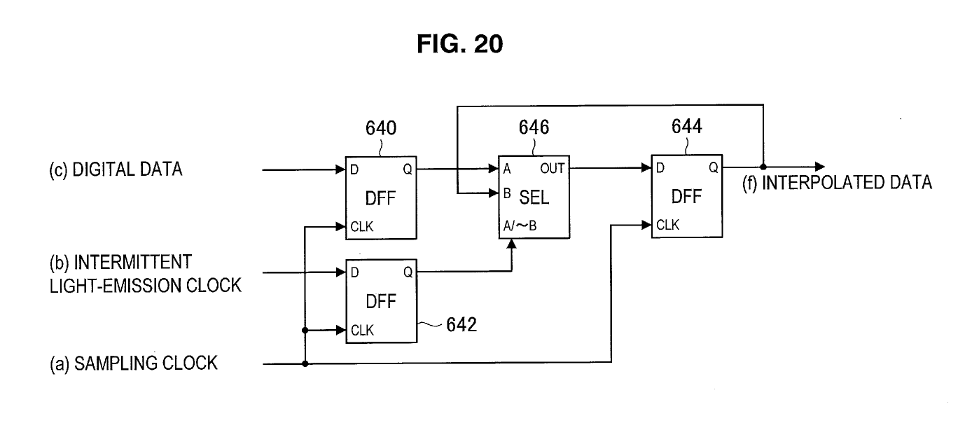

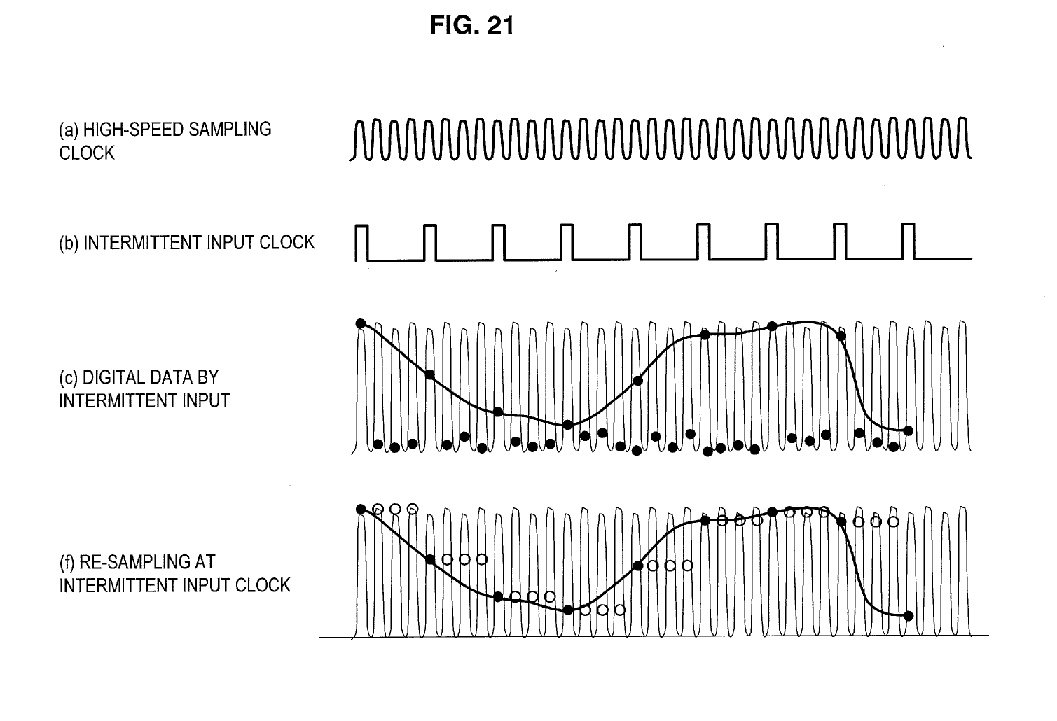

FIG. 20 is a schematic diagram illustrating an example of a configuration in which an output of the DEF 644 is fed back to an SEL 646 in the configuration of FIG. 18. In the configuration illustrated in FIG. 20, the SEL 646 replaces the digital data by the intermittent input of (c) at the timing at which the latch signal is received with (f) the interpolated data. In the configuration illustrated in FIG. 20, (f) the interpolated data becomes data for which the output of the DEF 644 is held, as illustrated in FIG. 21. Even in such a configuration, since the data is considered to be the data for which the output of the DEF 644 is held except for the value sampled at the clock Fc synchronized with the intermittent light emission, it is possible to prevent noise from being contained in the digital data sampled at a high speed.

As a presupposition of application of the embodiment to a system of the related art, an image acquisition range and a frame rate are first set as prerequisites so that an optical frequency band fo determined from NA of the objective lens of the microscope body 100, a wavelength of an excitation light source, and a beam speed becomes ½ or less of the intermittent light-emission frequency fc. Thus, when the sampling is performed at the frequency fc, the Nyquist sampling theorem is satisfied.

The clock Fc synchronized with the intermittent light emission is input to the re-sampling unit 620 or the clock Fc is generated in the re-sampling unit 620 by the digital PLL (D-PLL) or the like, and the digital data synchronously sampled in the interpolation circuit 630 is created using the clock Fc.

### 3. Third Embodiment

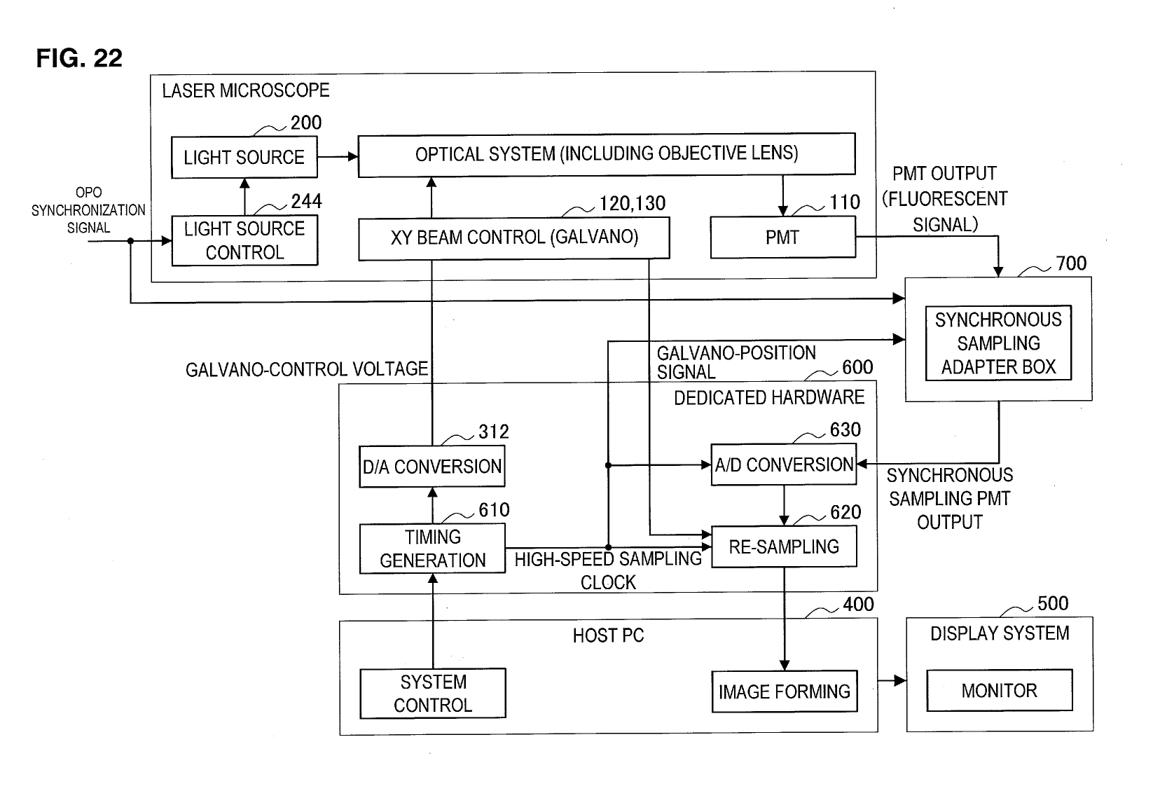

Next, a third embodiment of the present disclosure will be described. FIG. 22 is a schematic diagram illustrating the configuration of a system according to the third embodiment. In the system illustrated in FIG. 22, a synchronous sampling adapter (synchronous sampling adapter BOX (SSAB)) 700 is added in addition to the system of FIG. 10. The synchronous sampling adapter 700 is added to a microscope system of the related art, so that the same process as that of the above-described second embodiment is realized in the microscope system of the related art.

Conditions serving as requisites of the system are the same as those of the second embodiment. An image acquisition range and a frame rate are set so that an optical frequency band f₀ determined from NA of the objective lens of the microscope body 100, a wavelength of an excitation light source, and a beam speed becomes ½ or less of the intermittent light-emission frequency fc. Thus, when the sampling is performed at the frequency fc, the Nyquist sampling theorem is satisfied.

In FIG. 22, an output of the PMT 110 is input to the synchronous sampling adapter 700. The clock Fc synchronized with the intermittent light emission is input to the synchronous sampling adapter 700. An asynchronous high-speed sampling clock Fc may be input from the dedicated hardware 600 (or the outside of the system) or may be generated in the synchronous sampling adapter 700. The synchronous sampling adapter 700 performs the same process as that of the second embodiment to convert digital data into an analog signal and input the analog signal as a PMT output signal to the dedicated hardware 600.

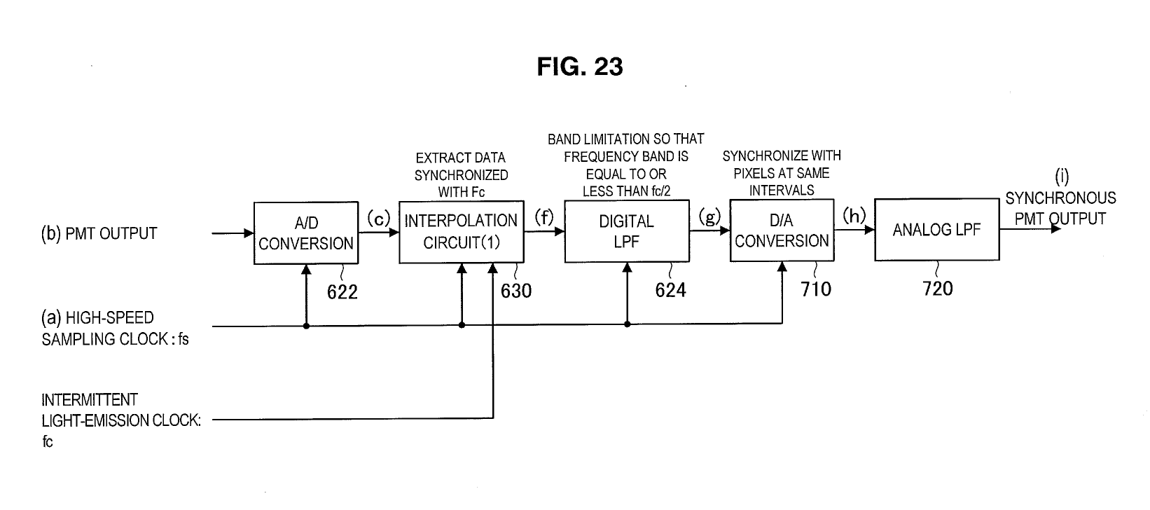

FIG. 23 is a schematic diagram illustrating a basic configuration of the synchronous sampling adapter 700. The synchronous sampling adapter 700 includes an A/D conversion unit 622, an interpolation circuit 630, a digital LPF 624, a D/A conversion unit 710, and an analog LPF 720. The configurations of the A/D conversion unit 622, the interpolation circuit 630, and the digital LPF 624 are the same as those of the second embodiment.

As in the second embodiment, the A/D conversion unit 622 in the synchronous sampling adapter 700 re-samples the digital data sampled asynchronously at a high speed at the sampling frequency Fs at the clock Fc synchronized with the intermittent light emission in the interpolation circuit 630 to generate synchronously sampled digital data. The synchronous clock Fc may be input from the outside or may be generated internally by the digital PLL (D-PLL) or the like. The digital LPF 624 is assumed to change a pass-band according to the synchronous clock Fc. Then, the digital data generated in the interpolation circuit 630 passes through the digital LPF 624 performing the band limitation so that the frequency band is a frequency equal to or less than Fc/2, is subjected to D/A conversion in the D/A conversion unit 710 to return to the analog signal, passes through a fixed analog LPF 720 performing band limitation so that the frequency band is equal to or less than the maximum value of Fc, and sampling is performed at the synchronous clock to obtain an equivalent PMT signal. In the D/A conversion by the D/A conversion unit 710, the digital data is converted into the analog signal using Fs as a clock. The pass-band of the analog LPF 720 is fixed to ½ or less of the maximum frequency of Fc.

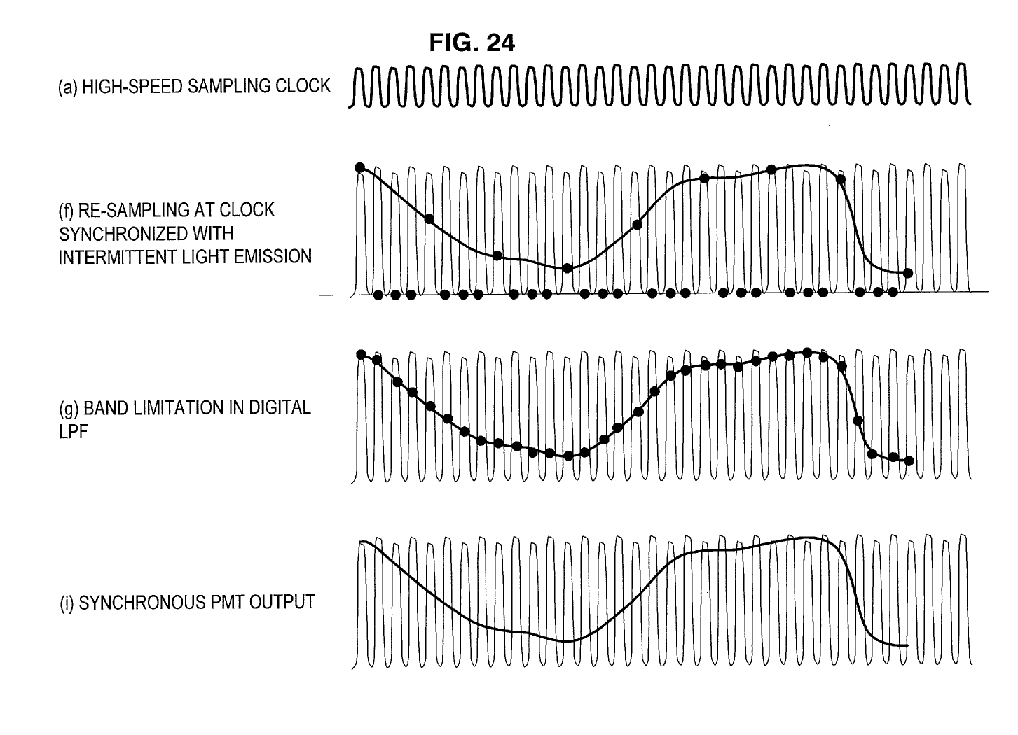

FIG. 24 is a schematic diagram illustrating waveforms processed by the synchronous sampling adapter 700 having the configuration illustrated in FIG. 23. FIG. 24 illustrates (a) a high-speed sampling clock, (f) a state re-sampled at the clock Fc synchronized with intermittent light emission, (g) a state of band limitation by the digital LPF, and (i) a synchronous PMT output output from the analog LPF 720. Here, (a), (f), (g), and (i) of FIG. 24 correspond to the signals of (a), (f), (g), and (i) of FIG. 23. As in the second embodiment, as illustrated in (f) of FIG. 24, a value is considered to be “0” except for a value sampled at the clock Fc synchronized with the intermittent light emission. Thus, since data at the time of no light emission of the light source 200 is not used, it is possible to prevent noise from being contained in the synchronous PMT output of (i).

Thus, the light source 200 including the wavelength conversion module (OPO) 250 can be combined without a change in the design of a laser microscope system (LSM: Laser Scanning Microscope) of the related art, and thus it is possible to obtain a signal from which noise at the time of no excitation with small phototoxicity is removed. By merely taking out the PMT output from the microscope body 100 and inputting an output of the synchronous sampling adapter as the MPT output to the dedicated hardware 600 via the synchronous sampling adapter, it is possible to obtain the signal from which noise at the time of no excitation with less phototoxicity is removed in a laser microscope system of the related art.

The output of the synchronous sampling adapter 700 is input to the dedicated hardware 600. The dedicated hardware 600 illustrated in FIG. 22 can have the same configuration as, for example, the dedicated hardware of the related art illustrated in FIG. 10. The A/D conversion unit 630 of the dedicated hardware 600 converts the output of the synchronous sampling adapter 700 into digital data using the sampling clock of the high-speed sampling. The timing generation unit 610 transmits the re-sampling clock signal to the re-sampling unit 620. The re-sampling unit 620 re-samples the digital data from the digital data sampled at a high speed and a galvano-position signal to form an image so that pixels on a sample are arranged at the same interval. Thus, by connecting the synchronous sampling adapter 700 to the system of the related art, the light source 200 including the wavelength conversion module (OPO) 250 can be combined without a change in the design of the laser microscope system (LSM: Laser Scanning Microscope) of the related art, and thus it is possible to obtain a signal from which noise at the time of no excitation with small phototoxicity is removed. The re-sampling unit 620 of the dedicated hardware 600 illustrated in FIG. 22 can have the configuration illustrated in FIG. 14 or the configuration described in FIG. 16.

The synchronous sampling adapter 700 can be widely applied to systems of the related art, and thus can be applied not only to a system performing intermittent light emission but also to a system acquiring image data intermittently by opening or closing of a shutter without performing the intermittent light emission. Even when the synchronous sampling adapter 700 is applied to a system acquiring image data intermittently by opening or closing of a shutter without performing the intermittent light emission, it is possible to obtain a signal from which noise at the time of no excitation is removed, and thus it is possible to suppress phototoxicity reliably.

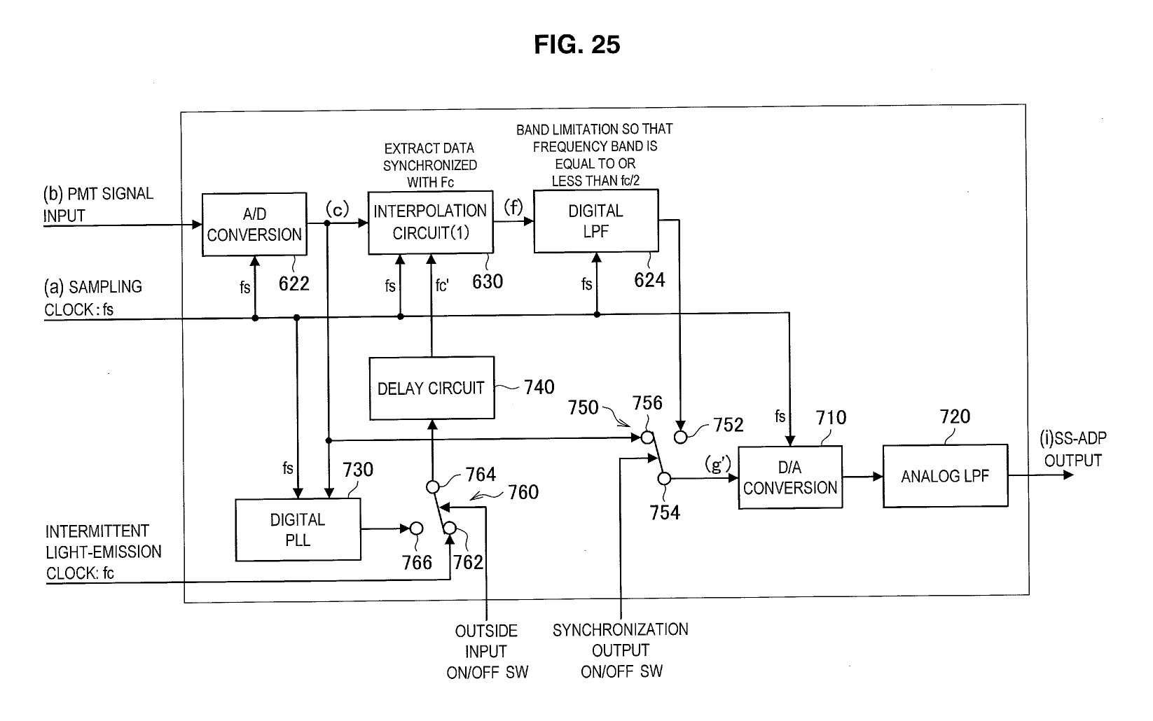

Hereinafter, several variations of the synchronous sampling adapter 700 will be described. FIG. 25 is a diagram illustrating an example of a configuration in which a digital PLL 730 and a delay circuit 740 are added to the synchronous sampling adapter 700 in FIG. 23. In an example illustrated in FIG. 25, switches 750 and 760 are installed.

When a synchronous output by the synchronous sampling adapter 700 is turned on, terminals 752 and 754 of the switch 750 are connected. Thus, the output of the digital LPF 624 is transmitted to the D/A conversion unit 710.

On the other hand, when the output is transmitted without performing the synchronization process of the synchronous sampling adapter 700, a terminal 756 and the terminal 754 of the switch 750 are connected and the output of the A/D conversion unit 622 is transmitted to the D/A conversion unit 710. In this case, the output is equivalent to the output substantially passing through the synchronous sampling adapter 700, excluding a quantization error.

When an external clock is turned on, terminals 762 and 764 of the switch 760 are connected. Thus, the clock Fc of the intermittent light-emission period input from the outside is transmitted to the delay circuit 740 and is transmitted to the interpolation circuit 630. When the external clock is turned off and the clock is internally generated, a terminal 766 and the terminal 764 of the switch 760 are connected. Thus, the clock Fc is generated in the digital PLL 730, is transmitted to the delay circuit 740, and is transmitted to the interpolation circuit 630. The digital PLL 730 generates the clock Fc based on the sampling clock Fs and the high-speed sampling data from the A/D conversion unit 622.

Thus, when the external clock is turned on, the re-sampling is performed using the intermittent light-emission clock Fc. When the external clock is turned off, the intermittent light-emission clock is extracted from the sampling clock Fs by the digital PLL and the re-sampling is performed.

The delay circuit 740 is installed for phase adjustment of the re-sampling. A clock Fc′ used to adjust the phase of the clock Fc is input to the interpolation circuit 630. When the phase adjustment is not performed, the clock Fc may be input directly to the interpolation circuit 630.

The synchronous sampling adapter 700 illustrated in FIG. 25 is connected to the microscope body 100 and the dedicated hardware 600 as in FIG. 22. An output from the detector 110 such as a photomultiplier tube (PMT) is input to the A/D conversion unit 622 of the synchronous sampling adapter 700. A signal ((i) digital data output) which is an output of the analog LPF 720 of the synchronous sampling adapter 700 is input to the A/D conversion unit 630 of the dedicated hardware 600.

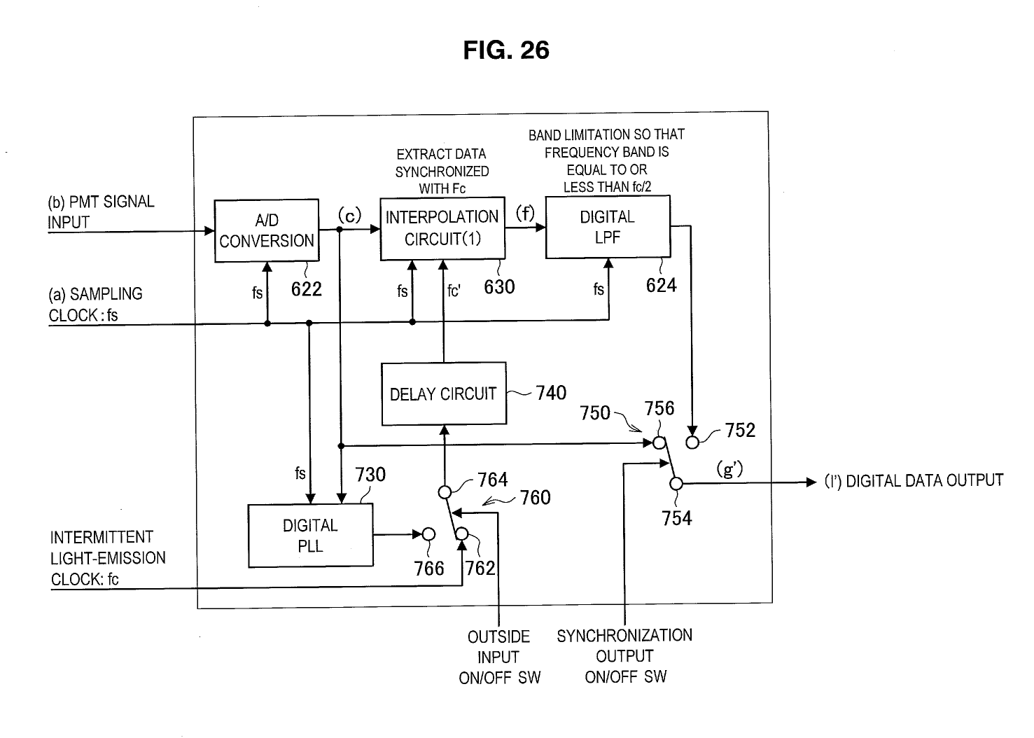

FIG. 26 is a schematic diagram illustrating the configuration of a synchronous sampling adapter 702 in which the D/A conversion unit 710 and the analog LPF 720 are omitted from the configuration of FIG. 25. When a synchronization output by the synchronous sampling adapter 700 is turned on even in the configuration of FIG. 26, the terminals 752 and 754 of the switch 750 are connected. Thus, an output of the digital LPF 624 is transmitted to the outside.

On the other hand, when the output is transmitted without performing the synchronization process of the synchronous sampling adapter 700, the terminals 756 and 754 of the switch 750 are connected and the output is transmitted from the A/D conversion unit 622 to the outside.

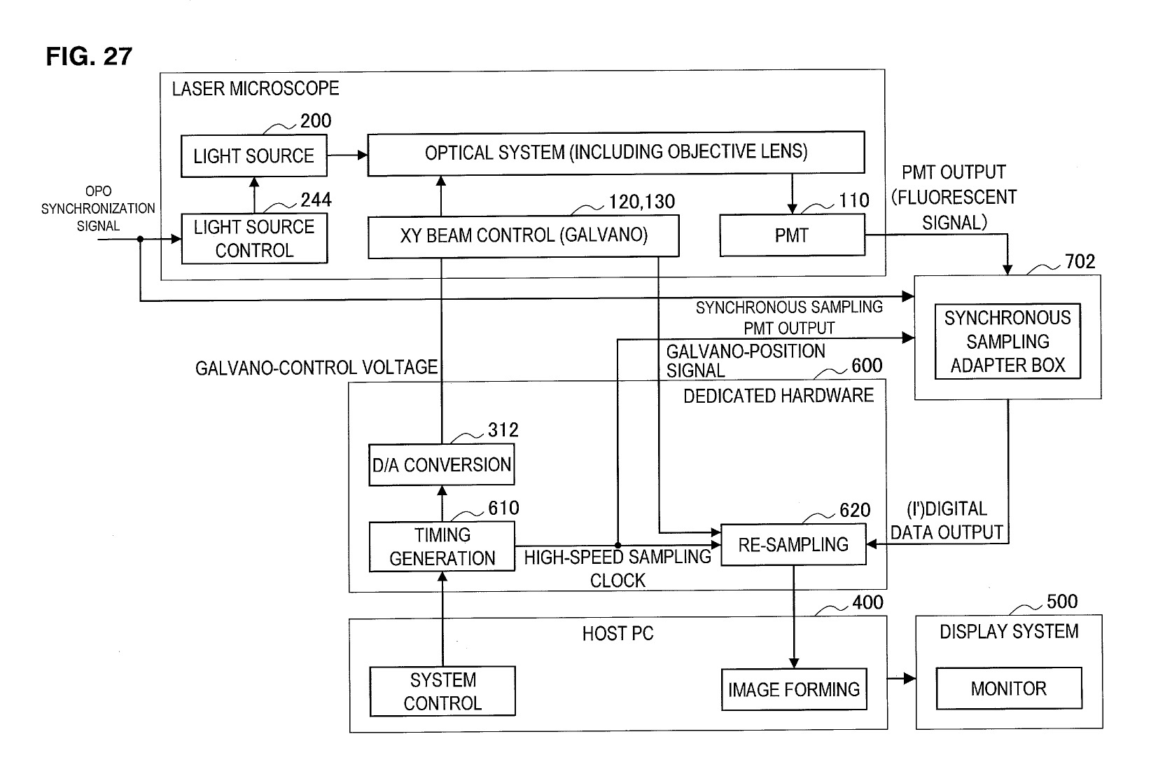

FIG. 27 is a schematic diagram illustrating the connection of the synchronous sampling adapter 702 illustrated in FIG. 26 with the microscope body 100 and the dedicated hardware 600. The dedicated hardware 600 illustrated in FIG. 22 can have the same configuration as, for example, the related art illustrated in FIG. 10. An output from the detector 110 such as a photomultiplier tube (PMT) is input to the A/D conversion unit 622 of the synchronous sampling adapter 702. A signal ((i) digital data output) which is an output of the analog LPF 720 of the synchronous sampling adapter 700 is input to the re-sampling unit 620 of the dedicated hardware 600. Since the output of the digital LPF 624 is not subjected to the D/A conversion in the synchronous sampling adapter 702 illustrated in FIG. 26, the output of the digital LPF 624 can be input directly to the re-sampling unit 620 of the dedicated hardware 600. Accordingly, the dedicated hardware 600 may not include the A/D conversion unit 630.

Thus, since the D/A conversion unit 710 and the analog LPF 720 are omitted in the synchronous sampling adapter 702 illustrated in FIG. 26, the output of the digital LPF 624 is input directly to the A/D conversion unit 622 of the re-sampling unit 620 of the dedicated hardware 600. The output of the digital LPF 624 is input to the interpolation circuit 632 (see FIG. 16) of the re-sampling unit 620. Accordingly, compared to FIG. 25, the synchronous sampling adapter 702 may not necessarily include the D/A conversion unit 710 and the analog LPF 720, and thus the configuration of a synchronous sampling adapter 704 can be further simplified. Since the dedicated hardware 600 may not include the A/D conversion unit 630, the configuration can be simplified.

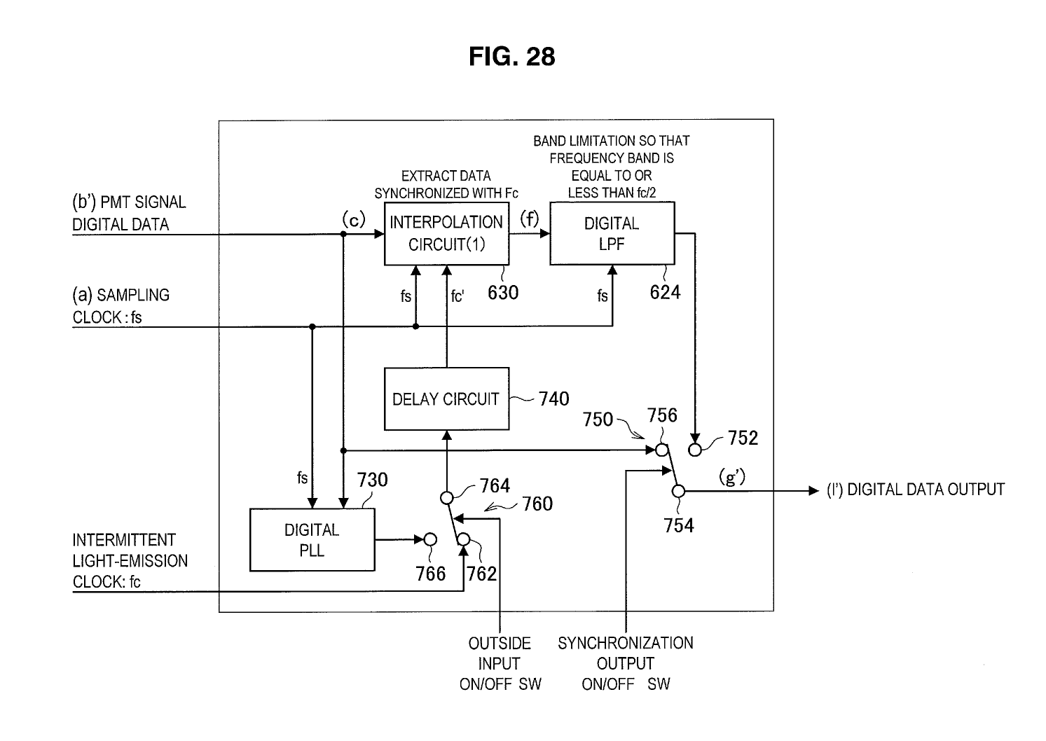

FIG. 28 is a schematic diagram illustrating the configuration of the synchronous sampling adapter 704 in which the A/D conversion unit 622, the D/A conversion unit 710, and the analog LPF 720 are omitted in the configuration of FIG. 25. When a synchronization output by the synchronous sampling adapter 700 is turned on even in the configuration of FIG. 28, the terminals 752 and 754 of the switch 750 are connected. Thus, an output of the digital LPF 624 is transmitted to the outside.

On the other hand, when the output is transmitted without performing the synchronization process of the synchronous sampling adapter 704, the terminals 756 and 754 of the switch 750 are connected and the output is transmitted from the detector 110 such as a photomultiplier tube (PMT) to the outside.

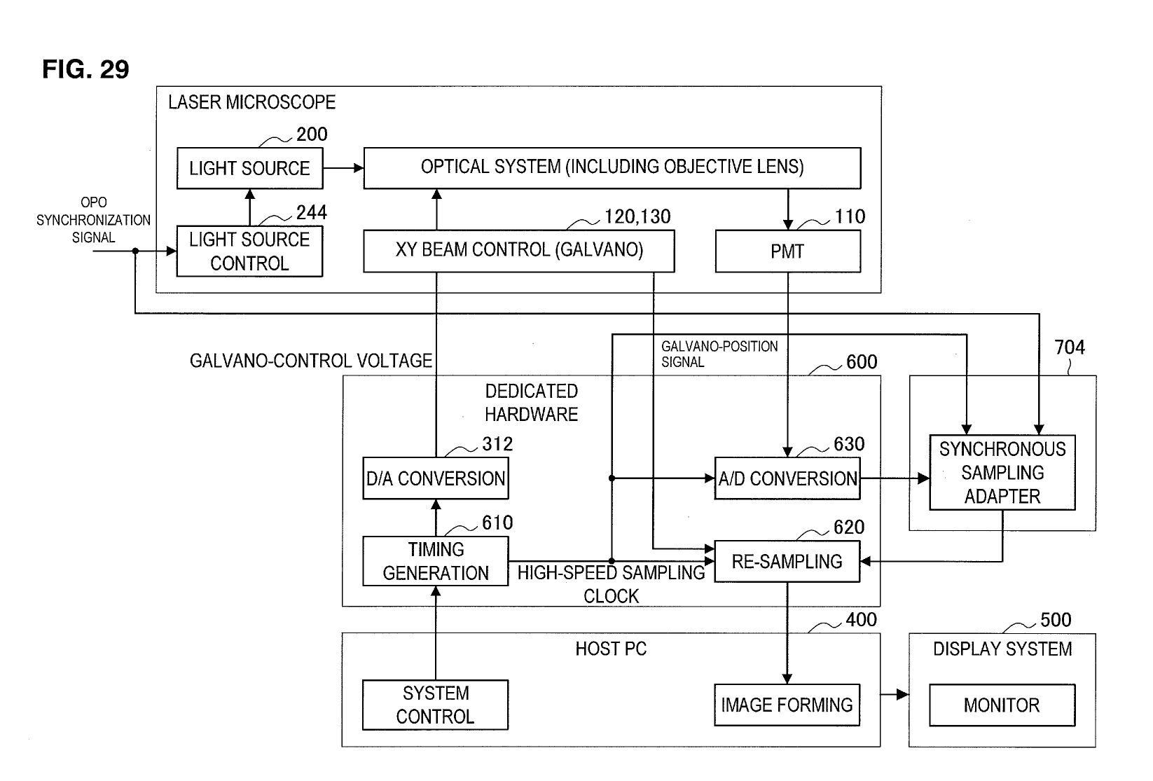

FIG. 29 is a schematic diagram illustrating the connection of the synchronous sampling adapter 704 illustrated in FIG. 28 with the microscope body 100 and the dedicated hardware 600. The dedicated hardware 600 illustrated in FIG. 29 can have the same configuration as, for example, the related art illustrated in FIG. 10. The A/D conversion unit 630 of the dedicated hardware 600 converts the output of the detector 110 such as a photomultiplier tube (PMT) into digital data using the sampling clock of the high-speed sampling. The digital data is input to the interpolation circuit 630 of the synchronous sampling adapter 704. A signal ((i′) digital data output) which is an output of the digital LPF 624 of the synchronous sampling adapter 704 is input to the re-sampling unit 620 of the dedicated hardware 600. Accordingly, by merely inputting an output of the synchronous sampling adapter 704 as the MPT output to the dedicated hardware 600 via the synchronous sampling adapter 704 between the A/D conversion unit 630 and the re-sampling unit 620 of the dedicated hardware 600, it is possible to obtain a signal from which noise at the time of no excitation with less phototoxicity is removed in a laser microscope system of the related art.

In the synchronous sampling adapter 704 in FIG. 29, the output of the A/D conversion unit 630 of the dedicated hardware 600 is input to the synchronous sampling adapter 704, and thus the synchronous sampling adapter 704 may not necessarily include the A/D conversion unit. As in the synchronous sampling adapter 702 in FIG. 26, the synchronous sampling adapter 704 may not necessarily include the D/A conversion unit 710 and the analog LPF 720. Accordingly, it is possible to further simplify the configuration of the synchronous sampling adapter 704.

Irrespective of kinds of the microscope system and the pulse laser light source, the influence of phototoxicity or color deterioration can be reduced by decreasing an intermittent light-emission duty, and thus it is possible to obtain a signal from which noise at the time of no excitation is removed.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) A laser scanning microscope system including:

a laser output unit configured to output a laser beam in a pulse light emission manner at a predetermined oscillation frequency;

an intermittent light-emission unit configured to intermittently emit the laser beam output from the laser output unit at a predetermined intermittent light-emission period;

a detector configured to convert fluorescence emitted from a fluorescent substance excited at a time of reception of the intermittently emitted laser beam into an electric signal; and

a sampling unit configured to sample the electric signal at a period corresponding to the intermittent light-emission period.

(2) The laser scanning microscope system according to (1), wherein the sampling unit includes

an A/D conversion unit configured to sample the electric signal at a sampling period higher than the intermittent light-emission period, and

a first interpolation unit configured to extract only data synchronized with the intermittent light-emission period from an output of the A/D conversion unit.

(3) The laser scanning microscope system according to (2), wherein the sampling unit further includes

a lowpass filter configured to perform band limitation on an output of the first interpolation unit so that a frequency band is equal to or less than ½ of a pixel frequency, and

a second interpolation unit configured to re-sample an output of the lowpass filter at a clock of the pixel frequency.

(4) The laser scanning microscope system according to any of (1) to (3), wherein an optical frequency band of the laser output unit is equal to or less than ½ of the intermittent light-emission frequency.
(5) The laser scanning microscope system according to (1), wherein frequencies and phases related to sampling and intermittent light emission are the same.
(6) The laser scanning microscope system according to any of (1) to (5), wherein the laser output unit is a mode-locked laser that outputs the laser beam for two-photon excitation.
(7) The laser scanning microscope system according to any of (1) to (5), wherein the laser output unit is a pulse laser configured by a mode-locked laser including an external resonator and a light source of a semiconductor optical amplifier and performs intermittent light emission by the intermittent light-emission unit while synchronizing the semiconductor optical amplifier with oscillation of the mode-locked laser.
(8) The laser scanning microscope system according to (1), wherein a sampling signal providing a period of sampling to the sampling unit and an intermittent light-emission signal providing the intermittent light-emission period to the intermittent light-emission unit are the same signals.
(9) The laser scanning microscope system according to any of (1) to (8), wherein the laser output unit or the intermittent light-emission unit causes the laser beam to be incident on an object during only a predetermined effective light-emission period.
(10) The laser scanning microscope system according to (9), including:

a first galvanomirror configured to perform scanning with the laser beam in a first direction of a surface of the object;

a second galvanomirror configured to perform scanning with the laser beam in a second direction perpendicular to the first direction of the surface of the object; and

a galvanomirror control unit configured to control the first and second galvanomirrors,

wherein, when the scanning in the first direction is completed, the galvanomirror control unit returns the laser beam to a start position of the first direction, and performs the scanning in the second direction by one line of the laser beam and subsequently performs the scanning in the first direction again, and

wherein the effective light-emission period is at least a part of a period in which the scanning in the first direction is performed.

(11) The laser scanning microscope system according to (1), including:

a lowpass filter configured to perform band limitation on the electric signal output from the detector and input the electric signal to the sampling unit,

wherein the lowpass filter performs the band limitation so that a Nyquist sampling theorem is established for a frequency of sampling.

(12) The laser scanning microscope system according to (11), wherein the lowpass filter performs the band limitation so that ½ or less of the frequency of the sampling is satisfied.
(13) The laser scanning microscope system according to (2), wherein a clock of the intermittent light-emission period is input to the first interpolation unit and the first interpolation unit extracts only data synchronized with the intermittent light-emission period based on the clock.
(14) The laser scanning microscope system according to (2), further including:

a clock generation unit configured to generate a clock corresponding to the intermittent light-emission period,

wherein the first interpolation unit extracts only data synchronized with the intermittent light-emission period based on the clock.

(15) A sampling device including:

an A/D conversion unit configured to sample an electric signal at a sampling period higher than a predetermined intermittent light-emission period when the electric signal is input from a detector of a laser scanning microscope system including a laser output unit that outputs a laser beam in a pulse light emission manner at a predetermined oscillation frequency, an intermittent light-emission unit that intermittently emits the laser beam output from the laser output unit at the intermittent light-emission period, and the detector that converts fluorescence emitted from a fluorescent substance excited at a time of reception of the intermittently emitted laser beam into the electric signal;

a first interpolation unit configured to extract only data synchronized with the intermittent light-emission period from an output of the A/D conversion unit;

a lowpass filter configured to perform band limitation on an output of the first interpolation unit so that a frequency band is equal to or less than ½ of a pixel frequency; and

a D/A conversion unit configured to perform D/A conversion on an output of the lowpass filter to return to an input terminal to which the electric signal of the detector of the laser scanning microscope system is input.

(16) A sampling device including:

an A/D conversion unit configured to sample an electric signal at a sampling period higher than a predetermined intermittent light-emission period when the electric signal is input from a detector of a laser scanning microscope system including a laser output unit that outputs a laser beam in a pulse light emission manner at a predetermined oscillation frequency, an intermittent light-emission unit that intermittently emits the laser beam output from the laser output unit at the intermittent light-emission period, and the detector that converts fluorescence emitted from a fluorescent substance excited at a time of reception of the intermittently emitted laser beam into the electric signal;

a first interpolation unit configured to extract only data synchronized with the intermittent light-emission period from an output of the A/D conversion unit; and

a lowpass filter configured to perform band limitation on an output of the first interpolation unit so that a frequency band is equal to or less than ½ of a pixel frequency and to return as an A/D conversion output of the electric signal of the detector to the laser scanning microscope system.

(17) A sampling device including:

a first interpolation unit configured to extract only data synchronized with a predetermined intermittent light-emission period from an output of an A/D conversion unit when the output of the A/D conversion unit of a laser scanning microscope system is input, the laser scanning microscope system including a laser output unit that outputs a laser beam in a pulse light emission manner at a predetermined oscillation frequency, an intermittent light-emission unit that intermittently emits the laser beam output from the laser output unit at the intermittent light-emission period, a detector that converts fluorescence emitted from a fluorescent substance excited at a time of reception of the intermittently emitted laser beam into an electric signal, and an A/D conversion unit that samples the electric signal at a sampling period higher than the intermittent light-emission period; and

a lowpass filter configured to perform band limitation on an output of the first interpolation unit so that a frequency band is equal to or less than ½ of a pixel frequency and return as an A/D conversion output of the electric signal of the detector to the laser scanning microscope system.

(18) The sampling device according to any of (15) to (17), wherein the laser output unit is a pulse laser configured by a mode-locked laser including an external resonator and a light source of a semiconductor optical amplifier and performs intermittent light emission by the intermittent light-emission unit while synchronizing the semiconductor optical amplifier with oscillation of the mode-locked laser.
(19) The sampling device according to any of (15) to (17), wherein the laser output unit is not able to be intermittently driven and the intermittent light-emission unit performs the intermittent light emission using a light modulation element that blocks a laser output from the laser output unit.

What is claimed is:

1. A laser scanning microscope system comprising:
a laser output unit configured to output a laser beam in a pulse light emission manner at a predetermined oscillation frequency;
an intermittent light-emission unit configured to intermittently emit the laser beam output from the laser output unit at a predetermined intermittent light-emission period;
a detector configured to convert fluorescence emitted from a fluorescent substance excited at a time of reception of the intermittently emitted laser beam into an electric signal; and
a sampling unit configured to sample the electric signal at a period corresponding to the intermittent light-emission period.

2. The laser scanning microscope system according to claim 1, wherein the sampling unit includes
an A/D conversion unit configured to sample the electric signal at a sampling period higher than the intermittent light-emission period, and
a first interpolation unit configured to extract only data synchronized with the intermittent light-emission period from an output of the A/D conversion unit.

3. The laser scanning microscope system according to claim 2, wherein the sampling unit further includes
a lowpass filter configured to perform band limitation on an output of the first interpolation unit so that a frequency band is equal to or less than ½ of a pixel frequency, and
a second interpolation unit configured to re-sample an output of the lowpass filter at a clock of the pixel frequency.

4. The laser scanning microscope system according to claim 1, wherein an optical frequency band of the laser output unit is equal to or less than ½ of the intermittent light-emission frequency.

5. The laser scanning microscope system according to claim 1, wherein frequencies and phases related to sampling and intermittent light emission are the same.

6. The laser scanning microscope system according to claim 1, wherein the laser output unit is a mode-locked laser that outputs the laser beam for two-photon excitation.

7. The laser scanning microscope system according to claim 1, wherein the laser output unit is a pulse laser configured by a mode-locked laser including an external resonator and a light source of a semiconductor optical amplifier and performs intermittent light emission by the intermittent light-emission unit while synchronizing the semiconductor optical amplifier with oscillation of the mode-locked laser.

8. The laser scanning microscope system according to claim 1, wherein a sampling signal providing a period of sampling to the sampling unit and an intermittent light-emission signal providing the intermittent light-emission period to the intermittent light-emission unit are the same signals.

9. The laser scanning microscope system according to claim 1, wherein the laser output unit or the intermittent light-emission unit causes the laser beam to be incident on an object during only a predetermined effective light-emission period.

10. The laser scanning microscope system according to claim 9, comprising:
a first galvanomirror configured to perform scanning with the laser beam in a first direction of a surface of the object;
a second galvanomirror configured to perform scanning with the laser beam in a second direction perpendicular to the first direction of the surface of the object; and
a galvanomirror control unit configured to control the first and second galvanomirrors,
wherein, when the scanning in the first direction is completed, the galvanomirror control unit returns the laser beam to a start position of the first direction, and performs the scanning in the second direction by one line of the laser beam and subsequently performs the scanning in the first direction again, and
wherein the effective light-emission period is at least a part of a period in which the scanning in the first direction is performed.

11. The laser scanning microscope system according to claim 1, comprising:
a lowpass filter configured to perform band limitation on the electric signal output from the detector and input the electric signal to the sampling unit,
wherein the lowpass filter performs the band limitation so that a Nyquist sampling theorem is established for a frequency of sampling.

12. The laser scanning microscope system according to claim 11, wherein the lowpass filter performs the band limitation so that ½ or less of the frequency of the sampling is satisfied.

13. The laser scanning microscope system according to claim 2, wherein a clock of the intermittent light-emission period is input to the first interpolation unit and the first interpolation unit extracts only data synchronized with the intermittent light-emission period based on the clock.

14. The laser scanning microscope system according to claim 2, further comprising:
a clock generation unit configured to generate a clock corresponding to the intermittent light-emission period,
wherein the first interpolation unit extracts only data synchronized with the intermittent light-emission period based on the clock.

15. A sampling device comprising:
an A/D conversion unit configured to sample an electric signal at a sampling period higher than a predetermined intermittent light-emission period when the electric signal is input from a detector of a laser scanning microscope system including a laser output unit that outputs a laser beam in a pulse light emission manner at a predetermined oscillation frequency, an intermittent light-emission unit that intermittently emits the laser beam output from the laser output unit at the intermittent light-emission period, and the detector that converts fluorescence emitted from a fluorescent substance excited at a time of reception of the intermittently emitted laser beam into the electric signal;
a first interpolation unit configured to extract only data synchronized with the intermittent light-emission period from an output of the A/D conversion unit;
a lowpass filter configured to perform band limitation on an output of the first interpolation unit so that a frequency band is equal to or less than ½ of a pixel frequency; and
a D/A conversion unit configured to perform D/A conversion on an output of the lowpass filter to return to an input terminal to which the electric signal of the detector of the laser scanning microscope system is input.

16. A sampling device comprising:
an A/D conversion unit configured to sample an electric signal at a sampling period higher than a predetermined intermittent light-emission period when the electric signal is input from a detector of a laser scanning microscope system including a laser output unit that outputs a laser beam in a pulse light emission manner at a predetermined oscillation frequency, an intermittent light-emission unit that intermittently emits the laser beam output from the laser output unit at the intermittent light-emission period, and the detector that converts fluorescence emitted from a fluorescent substance excited at a time of reception of the intermittently emitted laser beam into the electric signal;
a first interpolation unit configured to extract only data synchronized with the intermittent light-emission period from an output of the A/D conversion unit; and
a lowpass filter configured to perform band limitation on an output of the first interpolation unit so that a frequency band is equal to or less than ½ of a pixel frequency and to return as an A/D conversion output of the electric signal of the detector to the laser scanning microscope system.

17. A sampling device comprising:
a first interpolation unit configured to extract only data synchronized with a predetermined intermittent light-emission period from an output of an A/D conversion unit when the output of the A/D conversion unit of a laser scanning microscope system is input, the laser scanning microscope system including a laser output unit that outputs a laser beam in a pulse light emission manner at a predetermined oscillation frequency, an intermittent light-emission unit that intermittently emits the laser beam output from the laser output unit at the intermittent light-emission period, a detector that converts fluorescence emitted from a fluorescent substance excited at a time of reception of the intermittently emitted laser beam into an electric signal, and an A/D conversion unit that samples the electric signal at a sampling period higher than the intermittent light-emission period; and
a lowpass filter configured to perform band limitation on an output of the first interpolation unit so that a frequency band is equal to or less than ½ of a pixel frequency and return as an A/D conversion output of the electric signal of the detector to the laser scanning microscope system.

18. The sampling device according to claim 15, wherein the laser output unit is a pulse laser configured by a mode-locked laser including an external resonator and a light source of a semiconductor optical amplifier and performs intermittent light emission by the intermittent light-emission unit while synchronizing the semiconductor optical amplifier with oscillation of the mode-locked laser.

19. The sampling device according to claim 15, wherein the laser output unit is not able to be intermittently driven and the intermittent light-emission unit performs the intermittent light emission using a light modulation element that blocks a laser output from the laser output unit.
